(19) United States
(12) Patent Application Publication
(10) Pub. No.: US 2023/0103186 A1
(43) Pub. Date: Mar. 30, 2023

(54) OPTICAL UNIT AND SMARTPHONE

(71) Applicant: Nidec Corporation, Kyoto (JP)

(72) Inventors: Takayuki IWASE, Kyoto (JP); Tomohiro EGAWA, Kyoto (JP); Genki TANAKA, Kyoto (JP)

(21) Appl. No.: 17/950,150

(22) Filed: Sep. 22, 2022

(30) Foreign Application Priority Data
Sep. 30, 2021 (JP) 2021-162201

(51) Int. Cl. G02B 7/182; G03B 5/00; G03B 17/12; G02B 27/64

(52) U.S. Cl. CPC G02B 7/1821; G03B 5/00; G03B 17/12; G02B 27/646

(57) ABSTRACT

An optical assembly includes a holder on which an optical element that reflects light traveling to one side in a first direction to one side in a second direction intersecting with the first direction is mounted, a support that supports the holder, a fixed body that supports the support, a first swing mechanism that swings the support about a first swing axis with respect to the fixed body, a first magnet on any one of the holder, the support, and the fixed body, and a first magnetic body on another one of the holder, the support, and the fixed body. At least portions of the first magnet and the first magnetic body overlap each other when viewed from any one of the first direction, the second direction, and a third direction intersecting with each of the first direction and the second direction.

### CROSS-REFERENCE TO RELATED APPLICATIONS

The present application claims priority under 35 U.S.C. § 119 to Japanese Patent Application No. 2021-162201, filed on Sep. 30, 2021, the entire contents of which are hereby incorporated herein by reference.

### 1. Field of the Invention

The present disclosure relates to an optical assembly and a smartphone.

### 2. Background

Image blur may be generated due to camera shake during capturing a still image or a moving image with a camera. A camera shake correction device enabling the capturing of a clear image by preventing the image blur has been put into practical use.

For example, conventionally a reflection module including a reflection member, a holder, and a first housing is described. The reflection member is attached to the holder. The first housing accommodates the holder. The holder freely rotates relative to a first axis and a second axis within the first housing. In addition, a first yoke and a magnet that are magnetically attracted to each other are disposed on opposing surfaces of the holder and the first housing. The first yoke is provided as a magnetic material. The magnet is attached to a surface of the holder. The first yoke is attached to a surface of the first housing.

In a conventional reflection module, the magnet is usually attached to the recess of the holder, and the yoke is attached to the recess of the housing.

However, when the magnet and the yoke are attached to the recesses of the holder and the housing, sometimes the magnet and the yoke are displaced from predetermined positions in the recesses of the holder and the housing. In particular, when minute recesses of the holder and the housing are formed by resin molding, a tolerance is generated in the recess, so that sometimes the positions of the magnet and the yoke attached in the recess are shifted by the tolerance.

### SUMMARY

An optical assembly according to an example embodiment of the present disclosure includes a holder on which an optical element that reflects light traveling to one side in a first direction to one side in a second direction intersecting the first direction is mounted, a support that supports the holder, a fixed body that supports the support, a first swing mechanism that swings the support about a first swing axis with respect to the fixed body, a first magnet on any one of the holder, the support, and the fixed body, and a first magnetic body on another one of the holder, the support, and the fixed body. At least portions of the first magnet and the first magnetic body overlap each other when viewed from any one of the first direction, the second direction, and a third direction intersecting with each of the first direction and the second direction. At least one of the first magnet and the first magnetic body is located in a through-hole in at least one of the support and the fixed body.

A smartphone according to another example embodiment of the present disclosure includes the optical assembly described above.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view schematically illustrating a smartphone including an optical assembly according to an example embodiment of the present disclosure.

FIG. 2 is a perspective view illustrating an optical assembly according to an example embodiment of the present invention.

FIG. 3 is an exploded perspective view illustrating an optical assembly according to an example embodiment of the present invention disassembled into a movable body and a support body.

FIG. 4 is an exploded perspective view illustrating a movable body of an optical assembly according to an example embodiment of the present invention.

FIG. 5A is a sectional view taken along a line VA-VA in FIG. 2.

FIG. 5B is a sectional view taken along a line VB-VB in FIG. 2.

FIG. 5C is a sectional view taken along a line VC-VC in FIG. 2.

FIG. 5D is a sectional view taken along a line VD-VD in FIG. 2.

FIG. 6 is an exploded perspective view illustrating an optical element and a holder of an optical assembly according to an example embodiment of the present invention.

FIG. 7 is an exploded perspective view illustrating an optical element, a holder, and a preload assembly of an optical assembly according to an example embodiment of the present invention.

FIG. 8 is an exploded perspective view illustrating an optical element, a holder, a preload assembly, a first support, and a second magnet of an optical assembly according to an example embodiment of the present invention.

FIG. 9 is a perspective view illustrating a movable body of an optical assembly according to an example embodiment of the present invention.

FIG. 10 is a view illustrating a first support of an optical assembly according to an example embodiment of the present invention as viewed from one side X1 in a first direction X.

FIG. 11 is an exploded perspective view illustrating a support body of an optical assembly according to an example embodiment of the present invention.

FIG. 12 is a perspective view illustrating a periphery of a second support in an optical assembly according to an example embodiment of the present invention.

FIG. 13 is a view illustrating a second support of an optical assembly according to an example embodiment of the present invention as viewed from the other side X2 in the first direction X.

FIG. 14 is a view illustrating assembling of a fixed body in an optical assembly according to an example embodiment of the present invention.

FIG. 15 is a view illustrating the assembling of a fixed body in an optical assembly according to an example embodiment of the present invention.

FIG. 16 is a perspective view illustrating an optical assembly according to an example embodiment of the present invention.

FIG. 17 is a perspective view illustrating an optical assembly according to an example embodiment of the present invention.

FIG. 18 is a perspective view illustrating an optical assembly according to an example embodiment of the present invention.

FIG. 19A is an exploded perspective view when a fixed body of an optical assembly according to an example embodiment of the present invention is assembled using a jig.

FIG. 19B is an exploded perspective view when a fixed body of an optical assembly according to an example embodiment of the present invention is assembled using the jig.

FIG. 20 is a view illustrating a section of an optical assembly according to an example embodiment of the present invention.

FIG. 21 is a view illustrating a section of an optical assembly according to an example embodiment of the present invention.

FIG. 22 is a view illustrating a section of an optical assembly according to an example embodiment of the present invention.

### DETAILED DESCRIPTION

With reference to the drawings, example embodiments of the present disclosure will be described below. In the drawings, the same or corresponding parts are given the same reference signs and description thereof will not be repeated.

In the present specification, a first direction X, a second direction Y, and a third direction Z intersecting with each other are appropriately described for easy understanding. In the present description, the first direction X, the second direction Y, and the third direction Z are orthogonal to one another, but are not necessarily orthogonal to one another. One side in the first direction is referred to as one side X1 in the first direction X, and the other side in the first direction is referred to as the other side X2 in the first direction X. One side in the second direction is referred to as one side Y1 in the second direction Y, and the other side in the second direction is referred to as the other side Y2 in the second direction Y. One side in the third direction is referred to as one side Z1 in the third direction Z, and the other side in the third direction is referred to as the other side Z2 in the third direction Z. For convenience, the first direction X is sometimes described as an up-down direction. One side X1 in the first direction X corresponds to a lower side, and the other side X2 in the first direction X corresponds to an upper side. However, the up-down direction, the upward direction, and the lower direction are defined for convenience of the description, and do not necessarily coincide with the vertical direction. The up-down direction is defined just for convenience of the description, and does not limit an orientation during use and assembly of the optical assembly of the present disclosure.

In the present specification, in the positional relationship between any one of orientations, lines, and surfaces and another one, the term “parallel” means not only a state where both never cross each other no matter how long they extend, but also a state where both are substantially parallel. In addition, “perpendicular” and “orthogonal” include not only a state in which both of them intersect with each other at 90 degrees, but also a state in which they are substantially perpendicular and a state in which they are substantially orthogonal. That is, “parallel”, “perpendicular”, and “orthogonal” each includes a state in which the positional relationship between the two includes an angle shift that does not depart from the gist of the present disclosure.

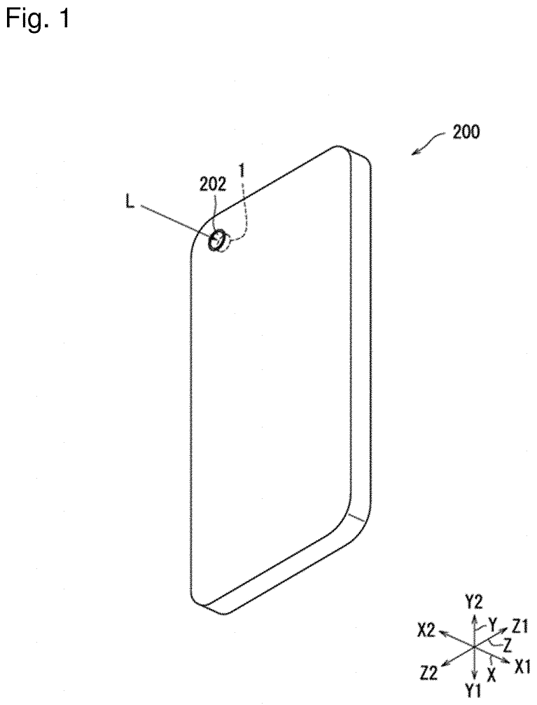

With reference to FIG. 1, an example of application of an optical assembly 1 will be described. FIG. 1 is a perspective view schematically illustrating a smartphone 200 including the optical assembly 1 according to an example embodiment of the present disclosure. The smartphone 200 includes the optical assembly 1. The optical assembly 1 reflects incident light in a certain direction. As illustrated in FIG. 1, for example, the optical assembly 1 is suitably used as an optical component of the smartphone 200. The application of the optical assembly 1 is not limited to the smartphone 200, but can be used for various devices such as a digital camera and a video camera.

The smartphone 200 includes a lens 202 on which light is incident. In the smartphone 200, the optical assembly 1 is disposed inside the lens 202. When light L enters the inside of the smartphone 200 through the lens 202, a traveling direction of the light L is changed by the optical assembly 1. The light L is imaged by an imaging element (not illustrated) through a lens unit (not illustrated).

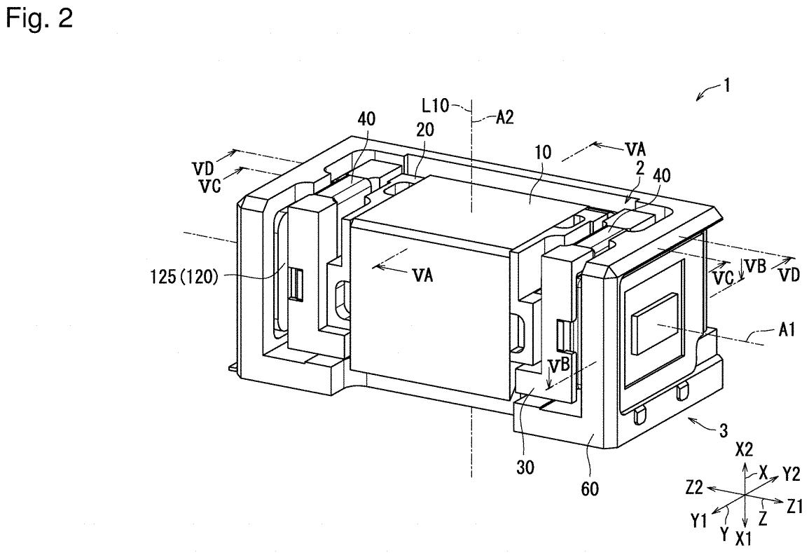

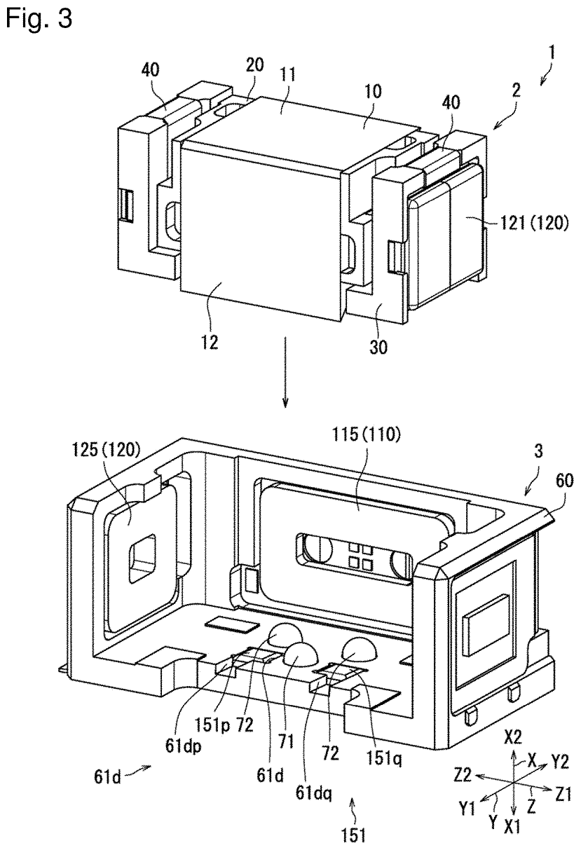

With reference to FIGS. 2 to 13, the optical assembly 1 will be described below. FIG. 2 is a perspective view illustrating the optical assembly 1 of the example embodiment. FIG. 3 is an exploded perspective view illustrating the optical assembly 1 of the example embodiment taken apart into a movable body 2 and a fixed body 3.

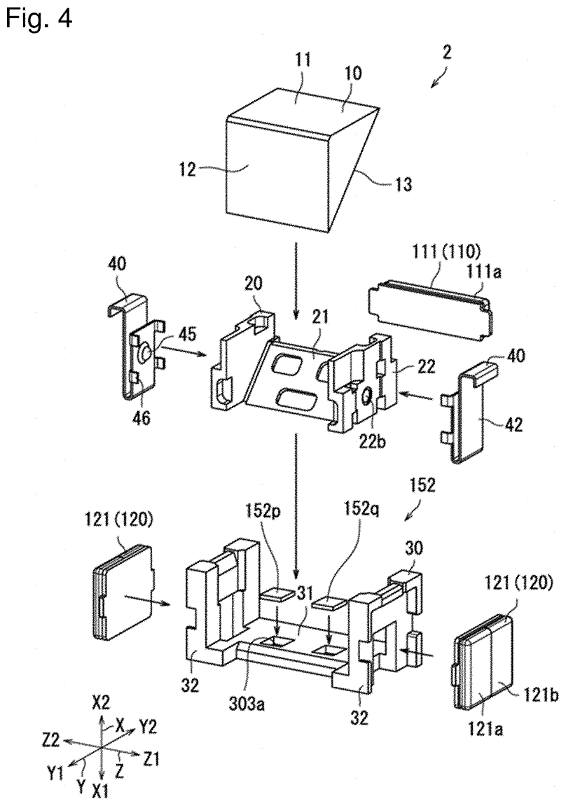

As illustrated in FIGS. 2 and 3, the optical assembly 1 includes at least the movable body 2, the fixed body 3, and a swing mechanism 120. The movable body 2 is swingably supported with respect to the fixed body 3. In the example embodiment, the optical assembly 1 includes a magnet 151 and a magnetic body 152 (FIG. 4). In the example embodiment, the optical assembly 1 further includes a swing mechanism 110. In the example embodiment, the optical assembly 1 further includes a preload assembly 40. The swing mechanism 120 is an example of the “swing mechanism” of the present disclosure. In the present specification, sometimes the swing mechanism 120 is referred to as a first swing mechanism and the swing mechanism 110 is referred to as a second swing mechanism. The details will be described below.

FIG. 4 is an exploded perspective view illustrating the movable body 2 of the optical assembly 1 of the example embodiment. As illustrated in FIGS. 2 to 4, the optical assembly 1 includes the movable body 2 and the fixed body 3. The fixed body 3 swingably supports the movable body 2 about a swing axis A2. The swing axis A2 is an example of the “first swing axis” of the present disclosure.

The movable body 2 includes an optical element 10. The movable body 2 includes a holder 20 and a first support 30. The first support 30 is an example of the “support”. The movable body 2 includes the preload assembly 40. The optical element 10 changes the traveling direction of light. The holder 20 holds the optical element 10. The first support 30 swingably supports the holder 20 and the optical element 10 about a swing axis A1 that intersects with the swing axis A2. The swing axis A1 is an example of the “second swing axis” of the present disclosure. The first support 30 is swingably supported by the fixed body 3 about the swing axis A2. More specifically, the first support 30 is swingably supported by a second support 60 of the fixed body 3 about the swing axis A2.

That is, the holder 20 is swingable with respect to the first support 30, and the first support 30 is swingable with respect to the second support 60. Accordingly, the optical element 10 can be swung about each of the swing axis A1 and the swing axis A2, so that an attitude of the optical element 10 can be corrected about each of the swing axis A1 and the swing axis A2. Consequently, the image blur can be prevented in two directions. As a result, correction accuracy can be improved as compared with the case in which the optical element 10 is swung about only one swing axis. The swing axis A1 is also referred to as a pitching axis. The swing axis A2 is also referred to as a roll axis.

In the example embodiment, as described above, the first support 30 supports the holder 20 and the optical element 10. The first support 30 is supported by the second support 60. That is, the holder 20 and the optical element 10 are indirectly supported by the second support 60 of the fixed body 3 with the first support 30 interposed therebetween. The holder 20 and the optical element 10 may be directly supported by the second support 60 of the fixed body 3 without the first support 30 interposed therebetween. That is, the movable body 2 may not include the first support 30.

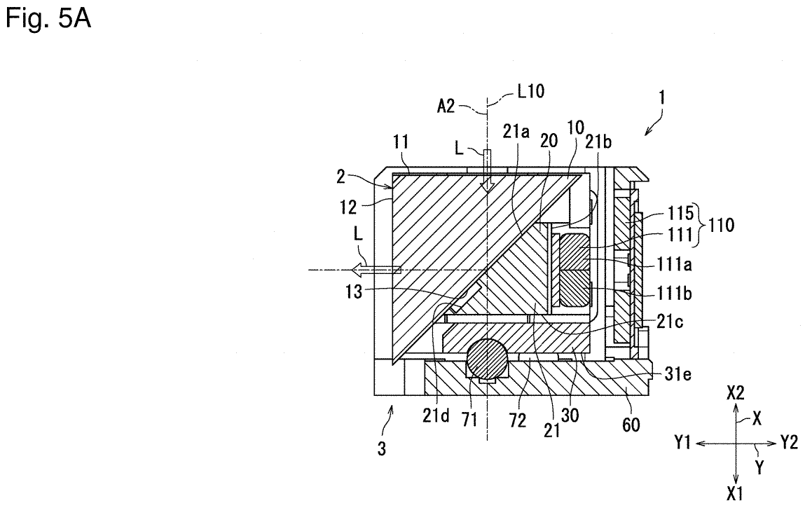

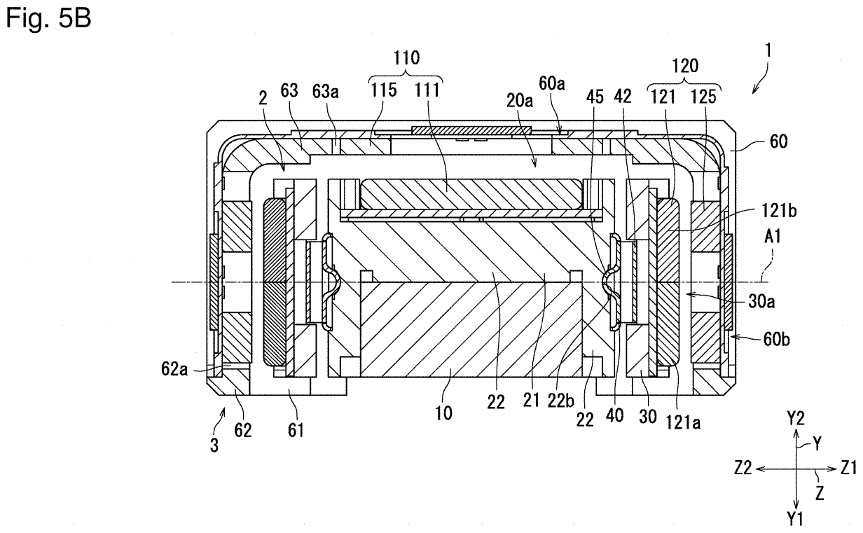

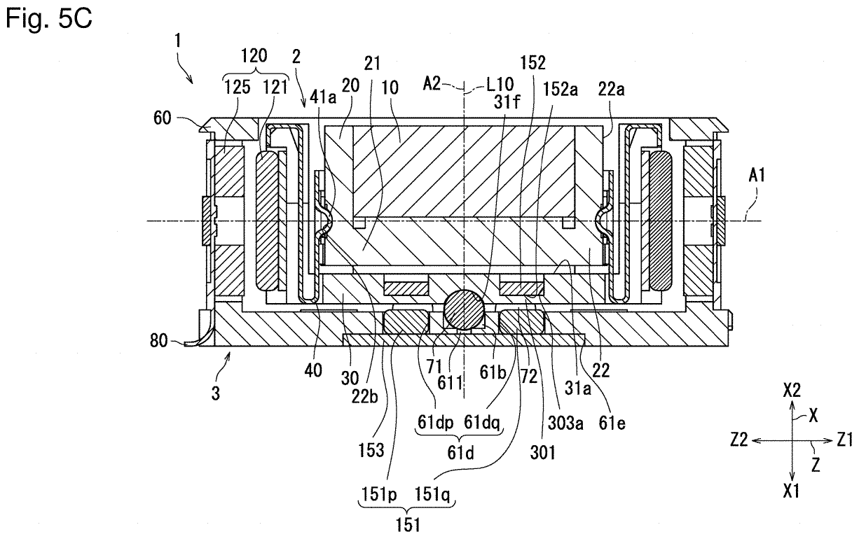

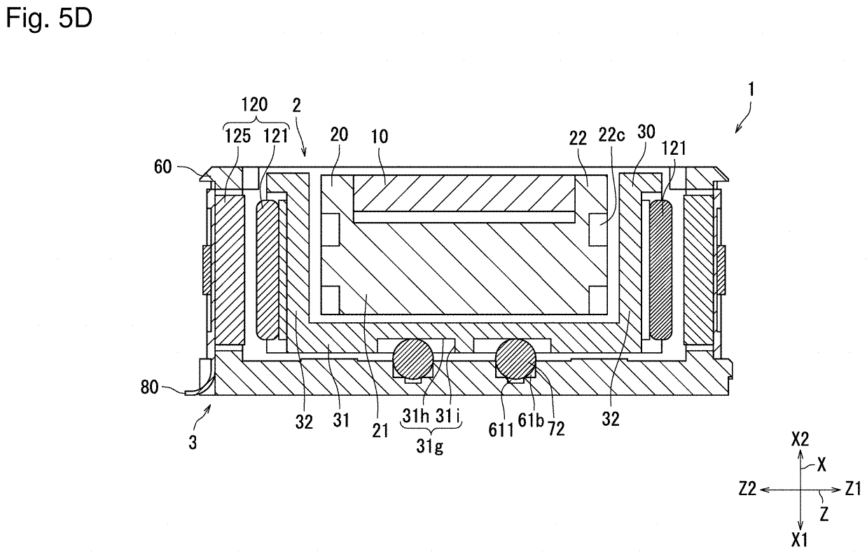

The swing axis A1 is an axis extending along the third direction Z intersecting with the first direction X and the second direction Y. The swing axis A2 is an axis extending along the first direction X. Accordingly, the optical element 10 can be swung about the swing axis A1 intersecting with the first direction X and the second direction Y. The optical element 10 can be swung about the swing axis A2 extending along the first direction X. Consequently, the attitude of the optical element 10 can be appropriately corrected. The first direction X and the second direction Y are directions along the traveling direction of the light L (FIG. 5A). That is, the optical element 10 can be swung about the swing axis A1 intersecting with the first direction X and the second direction Y that are the traveling direction of light. Accordingly, the attitude of the optical element 10 can be corrected more appropriately.

The first support 30 supports the holder 20 in the third direction Z. Accordingly, the first support 30 can be easily swung about the swing axis A1 extending along the third direction Z. Specifically, in the example embodiment, the first support 30 supports the holder 20 in the third direction Z through the preload assembly 40.

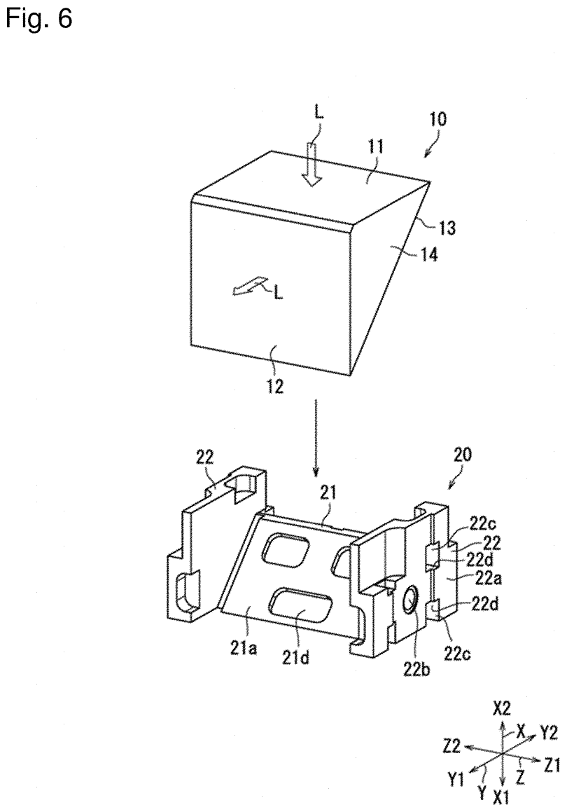

FIG. 5A is a sectional view taken along a line VA-VA in FIG. 2. FIG. 5B is a sectional view taken along a line VB-VB in FIG. 2. FIG. 5C is a sectional view taken along a line VC-VC in FIG. 2. FIG. 5D is a sectional view taken along a line VD-VD in FIG. 2. FIG. 6 is an exploded perspective view illustrating the optical element 10 and the holder 20 of the optical assembly 1 of the example embodiment. As illustrated in FIGS. 5A to 5D and 6, the optical element 10 is constituted of a prism. The prism is made of a transparent material that has a higher refractive index than air. For example, the optical element 10 may be a plate-shaped mirror. In the example embodiment, the optical element 10 has a substantially triangular prism shape. Specifically, the optical element 10 includes a light incident surface 11, a light emission surface 12, a reflection surface 13, and a pair of side surfaces 14. The light L is incident on the light incident surface 11. The light emission surface 12 is connected to the light incident surface 11. The light emission surface 12 is disposed perpendicular to the light incident surface 11. The reflection surface 13 is connected to the light incident surface 11 and the light emission surface 12. The reflection surface 13 is inclined by about 45 degrees with respect to each of the light incident surface 11 and the light emission surface 12. That is, the reflection surface 13 reflects the light L traveling to one side X1 in the first direction X to one side Y1 in the second direction Y intersecting with the first direction X. That is, the optical element 10 reflects the light L traveling to one side X1 in the first direction X to one side Y1 in the second direction Y intersecting with the first direction X. The pair of side surfaces 14 is connected to the light incident surface 11, the light emission surface 12, and the reflection surface 13.

An optical axis L10 of the optical element 10 and the swing axis A2 are disposed to overlap each other. In the present description, the optical axis L10 of the optical element 10 means an axis that coincides with at least any of an axis that is perpendicular to the light incident surface 11 of the optical element 10 and passes through the center of the reflection surface 13, a light axis of the lens 202 on which light is incident, an axis that passes through an intersection between the optical axis of the lens unit existing at the reflection destination and the reflection surface 13 and extends in the direction perpendicular to the optical axis of the lens unit, and an axis that passes through an intersection between a straight line passing through the center of the imaging element and the reflection surface 13 and extends in the direction perpendicular to a straight line passing through the imaging element. Typically, all the axis that is perpendicular to the light incident surface 11 of the optical element 10 and passes through the center of the reflection surface 13, the light axis of the lens 202 on which the light is incident, the axis that passes through an intersection between the optical axis of the lens unit present at the reflection destination and the reflection surface 13 and extends in the direction perpendicular to the optical axis of the lens unit, and the axis that passes through the intersection between the straight line passing through the center of the imaging element and the reflection surface 13 and extends in the direction perpendicular to the straight line passing through the imaging element coincide with one another.

At least one of the holder 20 and the first support 30 includes a recess recessed on the side opposite to the preload assembly 40 or a protrusion protruding toward the preload assembly 40. In the example embodiment, the holder 20 includes an axial recess 22b that is recessed on the side opposite to the preload assembly 40.

Specifically, for example, the holder 20 is made of resin. The holder 20 includes a holder body 21 and a pair of side surface units 22. The holder 20 includes a pair of opposing side surfaces 22a and the axial recess 22b.

The holder body 21 extends in the third direction Z. The holder body 21 includes a support surface 21a and a plurality of recesses 21d. In the example embodiment, the holder body 21 includes three recesses 21d. The support surface 21a supports the optical element 10. The support surface 21a is a surface that faces the reflection surface 13 of the optical element 10 and is connected to the pair of side surface units 22. The support surface 21a is an inclination surface inclined by about 45 degrees with respect to the incident direction of the light L, and is in contact with the reflection surface 13 of the optical element 10 over substantially an entire area of the inclination surface. The incident direction of the light L is a direction toward one side X1 in the first direction X. The recess 21d is disposed on the support surface 21a. The recess 21d is recessed on the side opposite to the optical element 10. The holder body 21 does not need to include the recess 21d.

The holder body 21 includes a back surface 21b and a lower surface 21c. The back surface 21b is connected to the support surface 21a at an end on the side opposite to the emission direction of the light L. The “emission direction of the light L” is one side Y1 in the second direction Y. The “end on the side opposite to the emission direction of the light L” is the end on the other side Y2 in the second direction Y. The lower surface 21c is connected to the support surface 21a and the back surface 21b.

The pair of side surface units 22 extend in an intersection direction intersecting with the third direction Z from the holder body 21. For example, the intersection direction includes the first direction X and the second direction Y. The pair of side surface units 22 are disposed at both ends of the holder body 21 in the third direction Z. The pair of side surface units 22 has a shape symmetrical to each other in the third direction Z. The pair of opposing side surfaces 22a is disposed on the pair of side surface units 22. The pair of opposing side surfaces 22a is opposite to a pair of the preload assemblies 40. A detailed structure of the preload assembly 40 will be described later. The axial recess 22b is disposed on the opposing side surface 22a. The axial recess 22b is recessed toward an inside of the holder 20 on the swing axis A1. The axial recess 22b accommodates at least a part of an axial protrusion 45 of the preload assembly 40. The axial recess 22b includes at least a part of a recessed spherical surface.

One of the holder 20 and the first support 30 includes a restriction recess 22c. The restriction recess 22c restricts a protrusion 46 of the preload assembly 40 from moving in the direction intersecting with the swing axis A1.

In the example embodiment, the holder 20 includes the restriction recess 22c. Specifically, the restriction recess 22c is disposed in the opposing side surface 22a. The restriction recess 22c restricts the preload assembly 40 from moving by at least a predetermined distance along the side surface unit 22. More specifically, the restriction recess 22c is recessed toward the inside of the holder 20 in the third direction Z. The restriction recess 22c includes an inner surface 22d. For example, the restriction recess 22c may be a recess in which both sides in the first direction X and both sides in the second direction Y are closed. For example, the restriction recess 22c may be a recess in which one side in the first direction X is opened or a recess in which one side in the second direction Y is opened.

The protrusion 46 of the preload assembly 40 is disposed in the restriction recess 22c. The protrusion 46 of the preload assembly 40 is separated from the inner surface 22d of the restriction recess 22c at a predetermined distance while the axial protrusion 45 is fitted in the axial recess 22b. On the other hand, when impact or the like is applied to the optical assembly 1 and when the holder 20 is about to move in the first direction X and the second direction Y by at least a predetermined distance, the protrusion 46 of the preload assembly 40 comes into contact with the inner surface 22d of the restriction recess 22c. Accordingly, the holder 20 can be prevented from coming off from the preload assembly 40. In the example embodiment, for example, four restriction recesses 22c are provided. The number of the restriction recesses 22c may be one, but preferably a plurality of restriction recesses 22c are provided.

The optical assembly 1 includes the preload assembly 40. The preload assembly 40 connects the holder 20 and the first support 30. The preload assembly 40 is elastically deformable. The preload assembly 40 is disposed on at least one of the holder 20 and the first support 30. The preload assembly 40 applies a preload to at least the other of the holder 20 and the first support 30 in an axial direction of the swing axis A1. Accordingly, the holder 20 can be prevented from displacing in the axial direction of the swing axis A1 with respect to the first support 30. Even when a manufacturing error is generated in dimensions of each member, rattling or the like can be prevented from being generated in the axial direction of the swing axis A1. In other words, for example, the position of the holder 20 can be prevented from being displaced in the axial direction of the swing axis A1. The axial direction of the swing axis A1 is a direction along the third direction Z. In the present description, “applying preload” means previously applying a load.

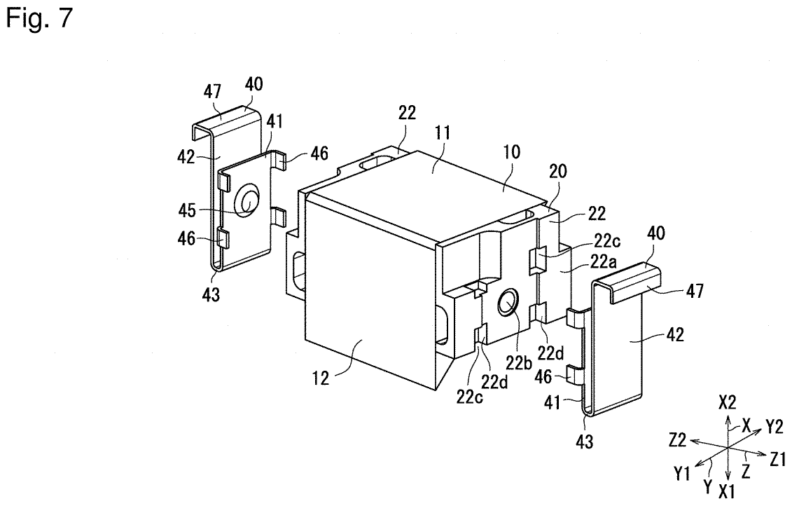

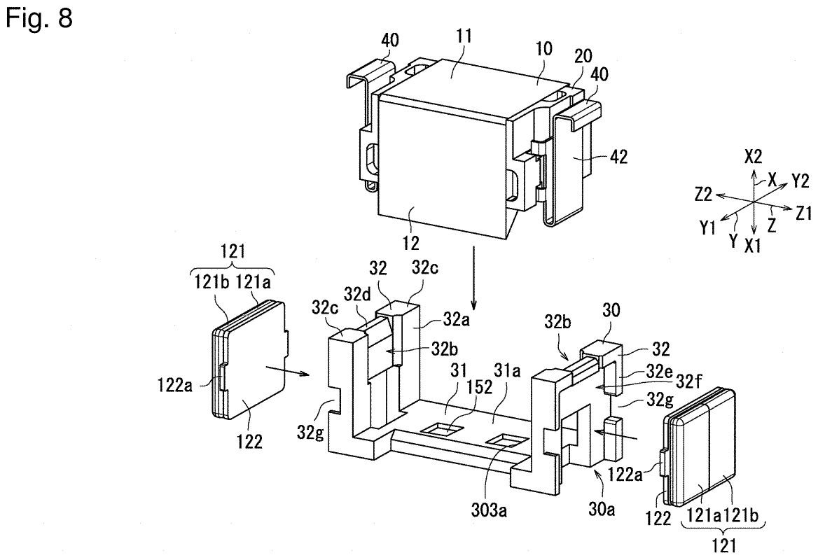

With reference to FIGS. 7 and 8, the detailed structure of the preload assembly 40 will be described below. FIG. 7 is an exploded perspective view illustrating the optical element 10, the holder 20, and the preload assembly 40 of the optical assembly 1 of the example embodiment. FIG. 8 is an exploded perspective view illustrating the optical element 10, the holder 20, the preload assembly 40, the first support 30, and a second magnet 121 of the optical assembly 1 of the example embodiment. As illustrated in FIGS. 7 and 8, the preload assembly 40 is disposed between the holder 20 and the first support 30. The preload assembly 40 applies the preload to the holder 20 in the axial direction of the swing axis A1.

Specifically, in the example embodiment, each preload assembly 40 is a single member. The preload assembly 40 is formed by bending one plate member. In the example embodiment, the preload assembly 40 is a plate spring. The preload assembly 40 is disposed on the first support 30.

The preload assembly 40 includes a first surface 41 located on the side of the holder 20, a second surface 42 located on the side of the first support 30, and a curved unit 43 connecting the first surface 41 and the second surface 42. Accordingly, the preload assembly 40 can be easily deformed in the axial direction of the swing axis A1. As a result, elastic force is generated due to the bending of the curved unit 43, so that the preload can be easily applied to the holder 20 in the axial direction with a simple configuration.

Specifically, the first surface 41 is opposite to the holder 20 in the axial direction of the swing axis A1. The first surface 41 is opposite to the side surface unit 22 of the holder 20. The first surface 41 extends along the first direction X and the second direction Y. The first surface 41 is disposed along the side surface unit 22. The second surface 42 is opposite to the first support 30 in the axial direction of the swing axis A1. The second surface 42 is opposite to the side surface unit 32 of the first support 30. The second surface 42 extends along the first direction X and the second direction Y. The second surface 42 is disposed along the side surface unit 32.

The curved unit 43 is elastically deformable. Consequently, the first surface 41 and the second surface 42 can move in a direction where the first surface 41 and the second surface 42 approach or separate from each other. In the example embodiment, the preload assembly 40 is compressed and deformed in the axial direction of the swing axis A1 such that the first surface 41 and the second surface 42 approach each other while the preload assembly 40 is disposed between the holder 20 and the first support 30. Accordingly, the preload assembly 40 applies the preload to the holder 20 by reaction force according to a deformation amount.

The preload assembly 40 includes a protrusion protruding toward at least one of the holder 20 and the first support 30 or a recess recessed on the side opposite to at least one of the holder 20 and the first support 30. The protrusion or the recess of the preload assembly 40 comes into contact with the protrusion or the recess of at least one of the holder 20 and the first support 30. In the example embodiment, the preload assembly 40 includes the axial protrusion 45. The axial protrusion 45 protrudes toward the holder 20. The axial protrusion 45 of the preload assembly 40 comes into contact with the axial recess 22b of the holder 20.

In the example embodiment, the axial protrusion 45 is disposed on the first surface 41. The axial protrusion 45 protrudes toward the holder 20 on the swing axis A1. The axial protrusion 45 has at least a part of a spherical surface. A part of the axial protrusion 45 is accommodated in the axial recess 22b. Accordingly, the axial protrusion 45 and the axial recess 22b are in point contact with each other, so that the preload assembly 40 can stably support the holder 20.

In the example embodiment, a pair of preload assemblies 40 is provided. That is, the optical assembly 1 includes the pair of preload assemblies 40. The pair of preload assemblies 40 is disposed on both sides of the swing axis A1 in the axial direction with respect to the holder 20. Accordingly, the holder 20 can be supported more stably as compared with the case where the preload assembly 40 is disposed only on one side of the holder 20.

Specifically, the axial protrusions 45 of the pair of preload assemblies 40 come into contact with the pair of axial recesses 22b of the holder 20. The holder 20 is supported by the preload assembly 40 from both sides in the axial direction of the swing axis A1 at two contact points in contact with the axial protrusion 45. Accordingly, the holder 20 can swing about the swing axis A1 passing through the two contact points.

The preload assembly 40 further includes the protrusion 46. The protrusion 46 is disposed on one of the first surface 41 and the second surface 42, and protrudes toward one of the holder 20 and the first support 30. In the example embodiment, the protrusion 46 is disposed on the first surface 41 similarly to the axial protrusion 45. The protrusion 46 protrudes toward the holder 20 in the direction along the swing axis A1. The protrusion 46 is provided corresponding to the restriction recess 22c. For example, four protrusions 46 are provided in each preload assembly 40. A part of the protrusion 46 is accommodated in the restriction recess 22c. The protrusion 46 is disposed so as to surround the axial protrusion 45. In other words, the axial protrusion 45 is disposed inside a region containing the four protrusions 46. For example, the number of protrusions 46 may be 1 to 3, or at least 5. The protrusion 46 is formed by bending the end of the first surface 41.

The preload assembly 40 includes an attachment unit 47. For example, the attachment unit 47 is disposed on the second surface 42. The attachment unit 47 is disposed at the upper end of the second surface 42. The attachment unit 47 is attached on the upper end of the side surface unit 32 of the first support 30. For example, the attachment unit 47 is attached to the side surface unit 32 by pinching the upper end of the side surface unit 32 in the first direction X. The preload assembly 40 needs not to include the attachment unit 47, and for example, may be fixed to the first support 30 using an adhesive or the like.

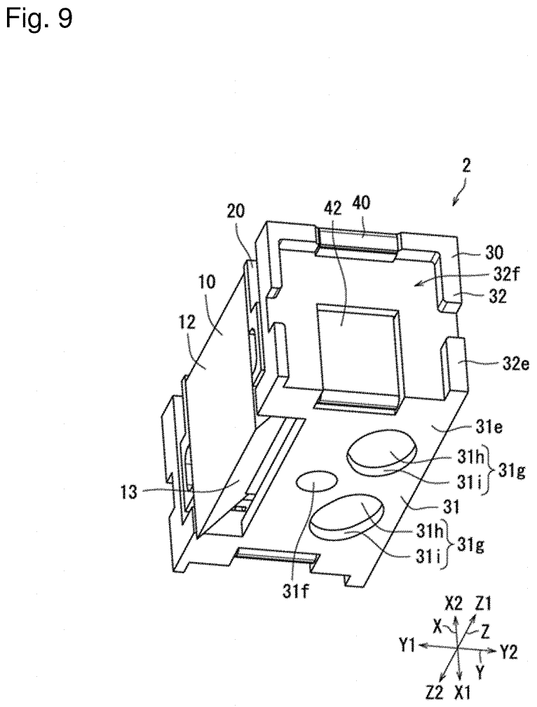

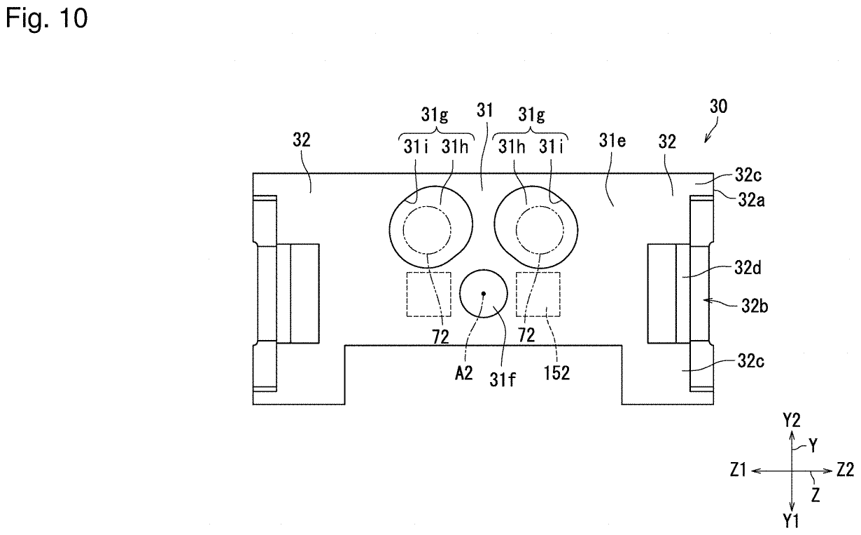

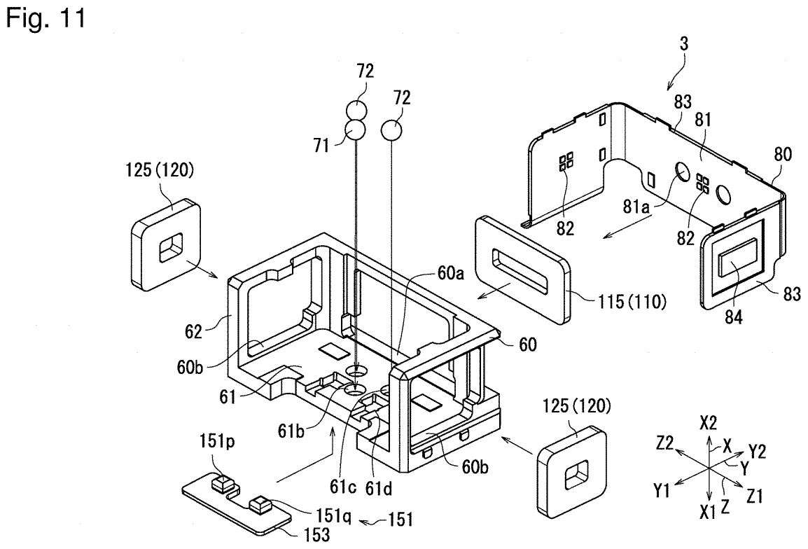

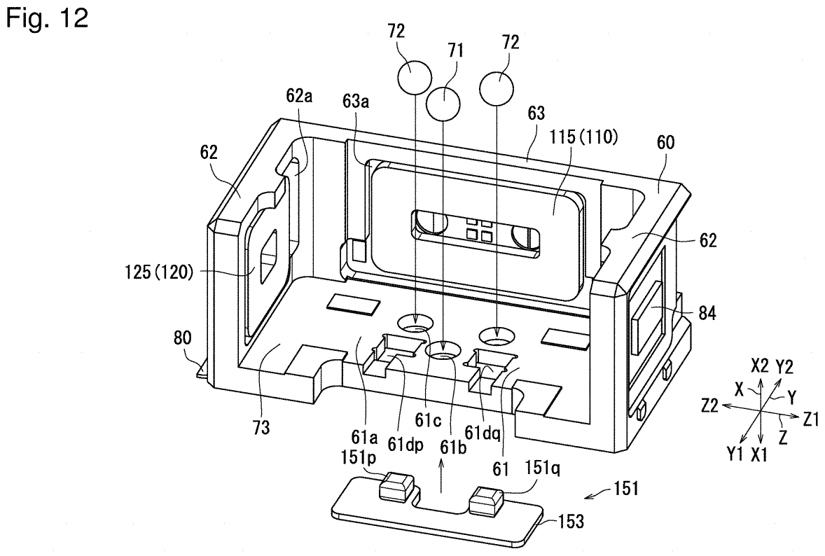

FIG. 9 is a perspective view illustrating the movable body 2 of the optical assembly 1 of the example embodiment. FIG. 10 is a view illustrating the first support 30 of the optical assembly 1 of the example embodiment as viewed from one side X1 in the first direction X. FIG. 11 is an exploded perspective view illustrating the fixed body 3 of the optical assembly 1 of the example embodiment. FIG. 12 is a perspective view illustrating a periphery of the second support 60 in the optical assembly 1 of the example embodiment.

As illustrated in FIGS. 9 to 12, one of the movable body 2 and the fixed body 3 includes a first protrusion 71 protruding toward the other of the movable body 2 and the fixed body 3. Specifically, one of the first support 30 and the second support 60 includes the first protrusion 71 protruding toward the other of the first support 30 and the second support 60. The other of the movable body 2 and the fixed body 3 comes into contact with the first protrusion 71. The first protrusion 71 is disposed on the swing axis A2. Accordingly, the movable body 2 swings about the first protrusion 71. Consequently, the length from the contact position between the movable body 2 and the fixed body 3 to the swing center can be reduced. Because the force required to swing the movable body 2 is a product of the length from the contact position to the swing center and frictional force, the force required to swing the movable body 2 can be reduced by disposing the first protrusion 71 on the swing axis A2. That is, the force required to drive the optical assembly 1 can be reduced. The material of the first protrusion 71 is not particularly limited, but for example, the first protrusion 71 is formed of ceramic, resin, or metal.

The first protrusion 71 is disposed on the swing axis A2, so that the contact position between the movable body 2 and the fixed body 3 does not move with respect to the first protrusion 71. Accordingly, the frictional force between the other of the movable body 2 and the fixed body 3 and the first protrusion 71 can be reduced, for example, as compared with the case where the other of the movable body 2 and the fixed body 3 swings with respect to the first protrusion 71 when the movable body 2 swings. The optical axis L10 and the swing axis A2 are disposed to overlap each other, so that the optical axis L10 can be prevented from deviating from the swing axis A2 when the movable body 2 is swung.

In the example embodiment, the fixed body 3 includes the first protrusion 71. Accordingly, the first protrusion 71 can be prevented from rotating when the movable body 2 swings. Consequently, the movable body 2 can be stably supported by the first protrusion 71. As a result, the swing of the movable body 2 is stabilized.

One of the movable body 2 and the fixed body 3 includes a plurality of second protrusions 72 protruding toward the other of the movable body 2 and the fixed body 3. Specifically, one of the first support 30 and the second support 60 includes the plurality of second protrusions 72 protruding toward the other of the first support 30 and the second support 60. The plurality of second protrusions 72 are disposed at positions separated from the swing axis A2. The other of the movable body 2 and the fixed body 3 comes into contact with the plurality of second protrusions 72. The first protrusion 71 and the plurality of second protrusions 72 are disposed on the same plane intersecting with the swing axis A2. Accordingly, the movable body 2 can be supported by the first protrusion 71 and the plurality of second protrusions 72 disposed on the same plane. As a result, the movable body 2 can be stably supported. Examples of the same plane on which the first protrusion 71 and the plurality of second protrusions 72 are disposed include a plane including an opposing surface 61a and a plane including a lower surface 31e. The material of the second protrusion 72 is not particularly limited, but for example, the second protrusion 72 is formed of ceramic, resin, or metal.

The position of the second protrusion 72 is constant. In other words, the second protrusion 72 does not move with respect to one of the movable body 2 and the fixed body 3. In the example embodiment, the second protrusion 72 does not move with respect to the fixed body 3. In other words, in the example embodiment, the position of the second protrusion 72 with respect to the fixed body 3 is constant even when the movable body 2 swings. Accordingly, the movable body 2 can be supported more stably.

In the example embodiment, the number of second protrusions 72 is two. Accordingly, the movable body 2 is supported by three protrusions (first protrusion 71 and second protrusions 72), so that the movable body 2 can be supported more stably as compared with the case where the movable body 2 is supported by at least four protrusions. In the example embodiment, the movable body 2 is in point contact at three points, so that the movable body 2 can be supported more stably.

The other of the movable body 2 and the fixed body 3 includes a first recess 31f recessed in the direction opposite to the first protrusion 71. The first recess 31f comes into contact with the first protrusion 71. Accordingly, the center of the first protrusion 71 can be prevented from deviating from the center axis of the first recess 31f by receiving the first protrusion 71 at the first recess 31f having the recessed shape. As a result, the image blur due to deviation of the center of rotation can be prevented. The swing of the movable body 2 can be prevented from becoming unstable due to the deviation of the rotation center. As a result, for example, the current value required to swing can be prevented from fluctuating.

In the example embodiment, the movable body 2 includes the first recess 31f, and the fixed body 3 includes the first protrusion 71. Accordingly, when the first protrusion 71 has the sphere, the movable body 2 can be assembled to the fixed body 3 while the sphere is disposed on the second support 60, so that the assembly work can be facilitated.

With reference to FIGS. 8 and 9, the structure around the first support 30 will be described in detail below. As illustrated in FIGS. 8 and 9, the first support 30 includes a support main body 31 and a pair of side surface units 32. The pair of side surface units 32 is disposed on both sides of the holder 20 in the axial direction of the swing axis A1. The support main body 31 connects the pair of side surface units 32.

The support main body 31 includes an upper surface 31a. The upper surface 31a is opposite to the holder 20 in the first direction X. The upper surface 31a is separated from the bottom surface of the holder 20.

The pair of side surface units 32 is disposed at both ends of the support main body 31 in the third direction Z. The pair of side surface units 32 has the shapes symmetrical to each other in the third direction Z. The side surface unit 32 includes an inner side surface 32a. The inner side surface 32a is opposite to the holder 20 in the third direction Z.

One of the first support 30 and the holder 20 includes a groove 32b. The groove 32b is recessed on the side opposite to the other of the first support 30 and the holder 20 on the swing axis A1. Accordingly, the holder 20 and the preload assembly 40 can be easily attached to the first support 30 by moving the preload assembly 40 along the groove 32b. In the example embodiment, the first support 30 includes the groove 32b. The groove 32b is recessed on the side opposite to the holder 20 on the swing axis A1. The groove 32b accommodates at least a part of the preload assembly 40 and extends in the direction intersecting with the swing axis A1.

In the example embodiment, the groove 32b is disposed on the inner side surface 32a. The groove 32b accommodates a part of the preload assembly 40. The groove 32b extends in the first direction X.

Each side surface unit 32 includes a pair of columns 32c and a connection unit 32d. The pair of columns 32c is separated from each other in the second direction Y. The column 32c extends in the first direction X. The connection unit 32d connects upper portions of the columns 32c to each other. The length of the connection unit 32d in the third direction Z is shorter than the length of the column 32c in the third direction Z. The groove 32b is formed by the pair of columns 32c and the connection unit 32d.

The preload assembly 40 can move along the groove 32b. In the example embodiment, the preload assembly 40 can move in the first direction X along the groove 32b. The attachment unit 47 of the preload assembly 40 pinches the connection unit 32d in the third direction Z by moving the preload assembly 40 along the groove 32b. Consequently, the preload assembly 40 is fixed to the first support 30.

The side surface unit 32 includes an outer side surface 32e and an accommodation recess 32f. The outer side surface 32e faces the outside of the third direction Z. The accommodation recess 32f is disposed on the outer side surface 32e. The accommodation recess 32f accommodates at least a part of second magnets 121 of the swing mechanism 120. The side surface unit 32 includes a pair of notches 32g. The notch 32g is disposed at the end in the second direction Y of the accommodation recess 32f. A protrusion 122a of a magnet support plate 122 is disposed in the notch 32g. The magnet support plate 122 supports the second magnet 121. The notch 32g supports the magnet support plate 122. The material of the magnet support plate 122 is not particularly limited, but for example, a magnetic material may be used. In this case, the magnet support plate 122 is also called a back yoke. Magnetic leakage can be prevented using the magnet support plate 122 made of a magnetic material.

The other of the movable body 2 and the fixed body 3 includes a second recess 31g. In the example embodiment, the movable body 2 includes the second recess 31g. Specifically, the support main body 31 includes the lower surface 31e, the first recess 31f, and the second recess 31g. The lower surface 31e is opposite to the fixed body 3 in the first direction X. The first recess 31f and the second recess 31g are disposed in the lower surface 31e.

The first recess 31f is disposed on the swing axis A2. The first recess 31f has a part of a recessed spherical surface. Accordingly, because the first protrusion 71 is received by the recessed spherical surface, for example, the first protrusion 71 is less likely to laterally deviate in the first recess 31f. As a result, the movable body 2 can be stably supported. On the other hand, for example, when the first recess 31f has a rectangular section, the first protrusion 71 tends to laterally deviate with respect to the first recess 31f. In the example embodiment, for example, unlike the case where the first protrusion 71 and the first recess 31f have the rectangular cross section, the first protrusion 71 and the first recess 31f can be easily brought into point contact.

The second recess 31g is recessed in the direction opposite to the second protrusion 72. The second recess 31g is separated from the first recess 31f. That is, the second recess 31g is separated from the swing axis A2. A plurality of second recesses 31g are provided. In the example embodiment, two second recesses 31g are provided. The two second recesses 31g are disposed at equal distances to the swing axis A2. The second recess 31g includes a sliding surface 31h and an inner side surface 31i.

The second recess 31g comes into contact with the second protrusion 72. Specifically, the sliding surface 31h of the second recess 31g comes into contact with the second protrusion 72. The sliding surface 31h is disposed substantially parallel to the lower surface 31e. That is, a depth of the second recess 31g is substantially constant.

As illustrated in FIG. 10, a contour of the second recess 31g is disposed outside the second protrusion 72 as viewed from the optical axis direction. Accordingly, the second protrusion 72 can be prevented from coming into contact with the inner side surface 31i of the second recess 31g. As a result, friction between the second protrusion 72 and the second recess 31g can be prevented. Specifically, the inner side surface 31i surrounds the sliding surface 31h. The inner side surface 31i is separated from the second protrusion 72. That is, as viewed from the optical axis direction, the contour of the second recess 31g is separated with respect to the second protrusion 72. The inner side surface 31i is disposed at a position where the second protrusion 72 does not come into contact when the first support 30 is swung by the swing mechanism 120 about the swing axis A2.

As illustrated in FIGS. 3 and 5A, the second protrusion 72 is disposed on the other side Y2 in the second direction Y relative to the first recess 31f. Accordingly, the second protrusion 72 can be prevented from coming into contact with the reflection surface 13 of the optical element 10. As a result, a space where the optical element 10 is disposed can be easily secured. The larger optical element 10 can also be mounted. Specifically, a part of the reflection surface 13 protrudes on one side X1 in the first direction X and one side Y1 in the second direction Y with respect to the lower surface 31e. Accordingly, the optical element 10 can be prevented from coming into contact with a part of the first support 30 where the second protrusion 72 is disposed. As a result, the space where the optical element 10 is disposed can be easily secured.

As illustrated in FIGS. 11 and 12, the fixed body 3 includes the second support 60, the first protrusion 71, and the second protrusion 72. The fixed body 3 preferably includes the opposing surface 61a.

Specifically, the second support 60 supports the first support 30 while being swingable about the swing axis A2 intersecting with the swing axis A1. The second support 60 supports the first support 30 in the first direction X. That is, the second support 60 supports the movable body 2 in the first direction X. Accordingly, a change in the position of the optical element 10 can be prevented in the first direction X, so that a change in the position of the reflected light (the light L emitted from the optical element 10) can be prevented in the first direction X.

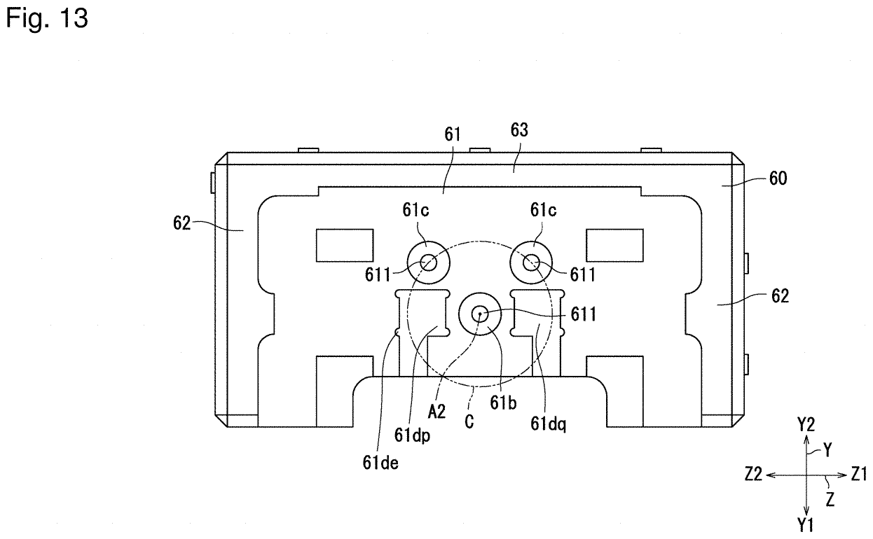

FIG. 13 is a view illustrating the second support 60 of the optical assembly 1 of the example embodiment as viewed from the other side X2 in the first direction X. As illustrated in FIGS. 11 to 13, the second support 60 includes a support body 61, a pair of side surface units 62, and a back surface unit 63. The support body 61 includes the opposing surface 61a, a first accommodation recess 61b, and at least two second accommodation recesses 61c. In the example embodiment, the support body 61 includes one first accommodation recess 61b and two second accommodation recesses 61c. In the example embodiment, an example in which the second support 60 includes the first accommodation recess 61b and the second accommodation recess 61c will be described. However, one of the movable body 2 and the fixed body 3 may include the first accommodation recess and the second accommodation recess that are recessed in the direction opposite to the other of the movable body 2 and the fixed body 3. For example, one of the movable body 2 and the fixed body 3 may include the first accommodation recess, and the other of the movable body 2 and the fixed body 3 may include the second accommodation recess.

The opposing surface 61a is opposite to the lower surface 31e of the first support 30 in the first direction X. The first accommodation recess 61b and the second accommodation recess 61c are disposed on the opposing surface 61a. The first accommodation recess 61b and the second accommodation recess 61c are recessed in the direction opposite to the movable body 2 in the first direction X. That is, the first accommodation recess 61b and the second accommodation recess 61c are recessed to one side X1 in the first direction X. The first accommodation recess 61b is opposite to the first recess 31f of the first support 30 in the first direction X. The first accommodation recess 61b is disposed on a same circumference C (see FIG. 13) about the swing axis A2. The first accommodation recess 61b accommodates a part of the first protrusion 71. Accordingly, the first protrusion 71 is disposed on the swing axis A2.

The second accommodation recess 61c is separated from the first accommodation recess 61b. Accordingly, the second accommodation recess 61c is separated from the swing axis A2. In the example embodiment, the second accommodation recess 61c is separated at a distance from the first accommodation recess 61b. The second accommodation recess 61c accommodates a part of the second protrusion 72. Accordingly, the plurality of second protrusions 72 are disposed on the same circumference C about the swing axis A2. Accordingly, the movable body 2 can be supported at a position with an equal distance from the first protrusion 71. As a result, the movable body 2 can be supported more stably. The axial direction of the swing axis A2 is the direction along the first direction X.

The two second accommodation recesses 61c are disposed at positions farther to the optical element 10 relative to the first accommodation recess 61b while arranged in the third direction Z.

The first accommodation recess 61b holds a part of the first protrusion 71. In the example embodiment, the lower half of the first protrusion 71 is disposed in the first accommodation recess 61b. The first protrusion 71 includes at least a part of a spherical surface. Accordingly, the first protrusion 71 comes into point contact with the other of the movable body 2 and the fixed body 3, so that the frictional force between the first protrusion 71 and the other of the movable body 2 and the fixed body 3 can be reduced. In the example embodiment, the first protrusion 71 comes into point contact with the movable body 2, so that the frictional force between the first protrusion 71 and the movable body 2 can be reduced.

In the example embodiment, the first protrusion 71 is a sphere. Accordingly, the friction between the first protrusion 71 and the first recess 31f becomes rolling friction. As a result, an increase in the frictional force between the first protrusion 71 and the first recess 31f can be prevented. Specifically, the first protrusion 71 can rotate in the first accommodation recess 61b. Accordingly, the friction between the first protrusion 71 and the first recess 31f becomes the rolling friction. The first protrusion 71 may be fixed to the first recess 31f by using, for example, an adhesive.

The second accommodation recess 61c holds a part of the second protrusion 72. In the example embodiment, the lower half of the second protrusion 72 is disposed in the second accommodation recess 61c. The second protrusion 72 includes at least a part of a spherical surface. Accordingly, the second protrusion 72 comes into point contact with the other of the movable body 2 and the fixed body 3, so that the frictional force between the second protrusion 72 and the other of the movable body 2 and the fixed body 3 can be reduced. In the example embodiment, the second protrusion 72 is in point contact with the movable body 2, so that the frictional force between the second protrusion 72 and the movable body 2 can be reduced.

In the example embodiment, the second protrusion 72 is a sphere. Accordingly, the friction between the second protrusion 72 and the other of the movable body 2 and the fixed body 3 becomes the rolling friction, so that the frictional force can be prevented. In the example embodiment, the friction between the second protrusion 72 and the movable body 2 becomes the rolling friction. Specifically, the second protrusion 72 can rotate in the second accommodation recess 61c. Accordingly, the friction between the second protrusion 72 and the second recess 31g of the first support 30 becomes the rolling friction. The second protrusion 72 may be fixed to the second recess 31g by using, for example, an adhesive.

As illustrated in FIGS. 5C and 13, the first accommodation recess 61b may include a center recess 611. The center recess 611 is disposed concentrically with the first accommodation recess 61b. The first protrusion 71 comes into contact with the edge of the center recess 611. A diameter of the center recess 611 is smaller than a diameter of the first protrusion 71. Accordingly, for example, even when a gap is generated between the outer peripheral surface of the first protrusion 71 and the inner peripheral surface of the first accommodation recess 61b, the first protrusion 71 can be positioned by the center recess 611. That is, the center of the first protrusion 71 can be disposed on the center axis of the center recess 611. As a result, the center of the first protrusion 71 can be easily disposed on the center axis of the first accommodation recess 61b.

As illustrated in FIGS. 5D and 13, the second accommodation recess 61c may include the center recess 611. The center recess 611 is disposed concentrically with the second accommodation recess 61c. The second protrusion 72 comes into contact with the edge of the center recess 611. The diameter of the center recess 611 is smaller than the diameter of the second protrusion 72. Accordingly, for example, even when the gap is generated between the outer peripheral surface of the second protrusion 72 and the inner peripheral surface of the second accommodation recess 61c, the second protrusion 72 can be positioned by the center recess 611. That is, the center of the second protrusion 72 can be disposed on the center axis of the center recess 611. As a result, the center of the second protrusion 72 can be easily disposed on the center axis of the second accommodation recess 61c.

The materials of the first protrusion 71 and the second protrusion 72 are ceramic. Accordingly, it is possible to suppress the first protrusion 71 and the second protrusion 72 can be prevented from becoming worn. The materials of the first protrusion 71 and the second protrusion 72 may be metal. Also in this case, the first protrusion 71 and the second protrusion 72 can be prevented from becoming worn. The entire first protrusion 71 and entire second protrusion 72 may be formed of metal, or for example, only the surfaces of the first protrusion 71 and the second protrusion 72 may be formed of metal by plating. The first protrusion 71 and the second protrusion 72 may be formed of resin.

The first protrusion 71 is disposed on one side X1 in the first direction X with respect to the reflection surface 13 (see FIG. 5A) of the optical element 10. Accordingly, the first protrusion 71 can be disposed without blocking the light path.

As illustrated in FIGS. 5C, 8, and 11, the optical assembly 1 includes the magnet 151 disposed on one of the movable body 2 and the fixed body 3 and the magnetic body 152 disposed on the other of the movable body 2 and the fixed body 3. The magnetic body 152 is a plate-like member made of a magnetic material. The magnet 151 is attached to an attachment plate 153. The magnet 151 and the magnetic body 152 overlap each other. Specifically, the magnet 151 and the magnetic body 152 overlap each other as viewed from the direction (first direction X) in which the fixed body 3 supports the movable body 2. Accordingly, in the direction in which the fixed body 3 supports the movable body 2, force (hereinafter, also referred to as attractive force) attracting the magnet 151 and the magnetic body 152 to each other can be generated between the magnet 151 and the magnetic body 152.

In this case, the magnet 151 includes a first magnet 151p and a second magnet 151q. The first magnet 151p and the second magnet 151q are arrayed along the third direction Z. The first magnet 151p is located on the other side Z2 in the third direction, and the second magnet 151q is located on one side Z1 in the third direction. In the present specification, sometimes the first magnet 151p and the second magnet 151q are collectively referred to as the magnet 151. Here, the first magnet 151p and the second magnet 151q are attached to the attachment plate 153.

Here, the magnetic body 152 includes a first magnetic body 152p and a second magnetic body 152b. The first magnetic body 152p and the second magnetic body 152b are arrayed along the third direction Z. The first magnetic body 152p is located on the other side Z2 in the third direction, and the second magnetic body 152b is located on one side Z1 in the third direction. In the present specification, sometimes the first magnetic body 152p and the second magnetic body 152b are collectively referred to as the magnetic body 152.

A through-hole 61d and a recess 61e (FIG. 5C) connected to the through-hole 61d are provided in the fixed body 3. The through-hole 61d penetrates the bottom of the fixed body 3 in the X-direction. The recess 61e is recessed from one side X1 of the fixed body 3 in the first direction.

When viewed from the direction (first direction X) in which the fixed body 3 supports the movable body 2, the first magnet 151p and the first magnetic body 152p overlap each other. In addition, the second magnet 151q and the second magnetic body 152b overlap each other when viewed from the direction (first direction X) in which the fixed body 3 supports the movable body 2.

As described above, because the magnet 151 and the magnetic body 152 overlap each other, the force acts between the movable body 2 and the fixed body 3 in the direction approaching each other. In other words, the attractive force acts on the movable body 2 and the fixed body 3. Accordingly, when the swing mechanism 110 and the swing mechanism 120 are not driven, the movable body 2 is held at a reference position by the attractive force between the magnet 151 and the magnetic body 152. As illustrated in FIG. 5B, the reference position is a position where the side surface unit 32 of the first support 30 and the side surface unit 62 of the second support 60 become parallel to each other. In addition, the movable body 2 can be prevented from moving to the other side X2 in the first direction X due to the attractive force generated between the magnet 151 and the magnetic body 152.

As illustrated in FIGS. 5C, 8, and 11, at least one of the movable body 2 and the fixed body 3 may include a covering unit 301 disposed between the magnet 151 and the magnetic body 152. The covering unit 301 covers at least a part of the contour of one of the magnet 151 and the magnetic body 152. Accordingly, the covering unit 301 can prevents one of the magnet 151 and the magnetic body 152 from peeling or positional displacement. For example, the covering unit 301 may cover the entire contour of one of the magnet 151 and the magnetic body 152.

The material of the covering unit 301 is not particularly limited, and for example, resin or metal can be used. In the example embodiment, for example, the covering unit 301 is formed of resin that is a non-magnetic material.

At least a part of one of the magnet 151 and the magnetic body 152 is disposed inside at least one of the movable body 2 and the fixed body 3. In the example embodiment, one of the magnet 151 and the magnetic body 152 is entirely disposed inside at least one of the movable body 2 and the fixed body 3. Accordingly, the increase in size of at least one of the movable body 2 and the fixed body 3 can be prevented, for example, unlike the case where one of the magnet 151 and the magnetic body 152 is disposed outside at least one of the movable body 2 and the fixed body 3.

In the example embodiment, the magnet 151 is disposed in the fixed body 3. The magnetic body 152 is disposed in the movable body 2. In the example embodiment, the movable body 2 includes the covering unit 301 disposed between the magnet 151 and the magnetic body 152. The covering unit 301 covers the entire surface (hereinafter, sometimes referred to as a lower surface 152a) of the magnetic body 152 on the side of the magnet 151. In the example embodiment, the entire magnetic body 152 is disposed inside the movable body 2.

In addition, at least one of the movable body 2 and the fixed body 3 includes a first member including an accommodation unit 303a in which one of the magnet 151 and the magnetic body 152 is disposed, and the covering unit 301. The first member and the covering unit 301 are a single member. Accordingly, for example, the number of components can be reduced as compared with the case where the first member and the covering unit 301 are formed as separate members. As described later, the first member and the covering unit 301 may be different from each other. In the example embodiment, the movable body 2 includes the support main body 31 including the accommodation unit 303a in which one of the magnet 151 and the magnetic body 152 is disposed. The support main body 31 is an example of the “first member” of the present disclosure. In addition, in the example embodiment, the movable body 2 includes the support main body 31 including the accommodation unit 303a in which the magnetic body 152 is disposed, and the covering unit 301.

In addition, the first member includes an opposite surface facing the side opposite to at least the other of the movable body 2 and the fixed body 3. The accommodation unit 303a is recessed from the opposite surface toward at least the other of the movable body 2 and the fixed body 3. Accordingly, the first member and the covering unit 301 can be easily formed of a single member. In the example embodiment, the support main body 31 includes the upper surface 31a facing the side opposite to the fixed body 3. That is, in the example embodiment, the support main body 31 includes the upper surface 31a facing the other side X2 in the first direction X at the position opposite to the lower surface 31e in the first direction X. The lower surface 31e is opposite to the other side X2 of the first direction X with respect to the opposing surface 61a of the fixed body 3. The accommodation unit 303a is recessed from the upper surface 31a toward the fixed body 3. The upper surface 31a is an example of the “opposite surface” of the present disclosure.

The magnetic body 152 is fitted in the accommodation unit 303a. Accordingly, the magnetic body 152 is fixed to the accommodation unit 303a. For example, the magnetic body 152 is fixed to the accommodation unit 303a by an adhesive or press-fitting.

A plurality of magnets 151 and a plurality of magnetic bodies 152 may be provided. In other words, the optical assembly 1 may include the plurality of magnets 151 and the plurality of magnetic bodies 152. In the example embodiment, the optical assembly 1 includes two magnets 151 and two magnetic bodies 152.

In the example embodiment, each of the magnets 151 and the magnetic bodies 152 are disposed symmetrically about the swing axis A2 in the third direction Z intersecting with the first direction X and the second direction Y. Accordingly, because the attractive force acts symmetrically about the swing axis A2, the swing of the movable body 2 is stabilized.

The other of the magnet 151 and the magnetic body 152 is disposed inside the other of the movable body 2 and the fixed body 3. In the example embodiment, the magnet 151 is disposed inside the fixed body 3. Specifically, the fixed body 3 includes the through-hole 61d. The fixed body 3 includes a plurality of through-holes 61d. In the example embodiment, the fixed body 3 includes two through-holes 61d.

In this case, the through-hole 61d includes a through-hole 61dp and a through-hole 61dq. For example, the first magnet 151p is disposed in the through-hole 61dp, and the second magnet 151q is disposed in the through-hole 61dq. The through-hole 61dp and the through-hole 61dq are arrayed along the third direction Z. The through-hole 61dp is located on the other side Z2 in the third direction, and the through-hole 61dq is located on one side Z1 in the third direction. In the present specification, sometimes the through-hole 61dp and the through-hole 61dq are collectively referred to as the through-hole 61d. At this point, the recess 61e is connected to each of the through-hole 61dp and the through-hole 61dq.

The through-hole 61d is disposed on the opposing surface 61a of the support body 61. The through-hole 61d is recessed in the direction opposite to the movable body 2 in the first direction X. That is, the through-hole 61d is recessed to one side X1 in the first direction X. The through-hole 61d is opposite to the magnetic body 152 in the first direction X. That is, the through-hole 61d and the magnetic body 152 overlap each other when viewed from the first direction X.

The magnet 151 is fitted in the through-hole 61d. Accordingly, the magnet 151 is fixed to the through-hole 61d. For example, the magnet 151 is fixed to the through-hole 61d by an adhesive or press-fitting.

In the example embodiment, the magnet 151 is fixed to the through-hole 61d by an adhesive. When the magnet 151 is fixed to the through-hole 61d, after an adhesive (not illustrated) is disposed in the through-hole 61d, the magnet 151 is disposed inside the through-hole 61d. Thus, the magnet 151 is fixed to the through-hole 61d by the adhesive (not illustrated).

In the example embodiment, the magnet 151 and the second magnet 121 described later of the swing mechanism 120 are different from each other. Accordingly, unlike the case where the magnet 151 constitutes the swing mechanism 120, the magnet 151 can be a dedicated magnet that generates the attractive force with the magnetic body 152, so that the magnet 151 can be disposed at the position close to the magnetic body 152. Consequently, even when the magnet 151 and the magnetic body 152 are made small, the attractive force can be sufficiently generated between the magnet 151 and the magnetic body 152.

As illustrated in FIGS. 12 and 13, in the second support 60, the pair of side surface units 62 is disposed at both ends in the third direction Z of the support body 61. The pair of side surface units 62 has a shape symmetrical to each other in the third direction Z. The side surface unit 62 includes an accommodation hole 62a in which a second coil 125 of the swing mechanism 120 is disposed. The accommodation hole 62a penetrates the side surface unit 62 in the thickness direction. That is, the accommodation hole 62a penetrates the side surface unit 62 in the third direction Z.

The back surface unit 63 is disposed at the end on the other side Y2 in the second direction Y of the support body 61. The back surface unit 63 includes an accommodation hole 63a in which a first coil 115 of the swing mechanism 110 is disposed. The accommodation hole 63a penetrates the back surface unit 63 in the thickness direction. That is, the accommodation hole 63a penetrates the back surface unit 63 in the second direction Y.

A flexible printed circuit (FPC) 80 is disposed so as to cover the outside of the pair of side surface units 62 and the outside of the back surface unit 63. For example, the FPC 80 includes a semiconductor element, a connection terminal, and a wiring. The FPC 80 supplies the power to the first coil 115 of the swing mechanism 110 and the second coil 125 of the swing mechanism 120 at predetermined timing.

Specifically, as illustrated in FIG. 11, the FPC 80 includes a substrate 81, a connection terminal 82, a reinforcing plate 83, and a magnetic body 84. For example, the substrate 81 is made of a polyimide substrate. The substrate 81 has flexibility. The substrate 81 includes a plurality of pin insertion holes 81a. The pin insertion holes 81a are opposite to the first coil 115. A coil pin (not illustrated) of the first coil 115 is disposed in each pin insertion hole 81a.

The connection terminal 82 is disposed on the substrate 81. The connection terminal 82 is opposite to the swing mechanism 110 and the swing mechanism 120. The connection terminal 82 is electrically connected to a terminal of a Hall element (not illustrated). For example, four connection terminals 82 are disposed for one Hall element. Three reinforcing plates 83 are disposed on the substrate 81. The reinforcing plate 83 is opposite to the swing mechanism 110 and the swing mechanism 120. The reinforcing plate 83 prevents the substrate 81 from bending.

Three magnetic bodies 84 are disposed on the substrate 81. Two of the magnetic bodies 84 are opposite to the second magnet 121 of the swing mechanism 120. The attractive force is generated between the second magnet 121 and the magnetic body 84 while the second coil 125 is not energized. Thus, the movable body 2 is disposed at the reference position in a rotation direction about the swing axis A2. The remaining one of the magnetic bodies 84 is opposite to a first magnet 111 of the swing mechanism 110. The attractive force is generated between the first magnet 111 and the magnetic body 84 while the first coil 115 is not energized. Thus, the movable body 2 is disposed at the reference position in a rotation direction about the swing axis A1. The generation of the attractive force between the first magnet 111 and the magnetic body 84 can prevent the holder 20 from coming off to one side Y1 of the second direction Y.

As illustrated in FIGS. 5A and 5B, the optical assembly 1 further includes the swing mechanism 110. The swing mechanism 110 swings the holder 20 with respect to the first support 30 about the swing axis A1. Accordingly, the optical element 10 can be easily swung about each of the two swing axes (the swing axis A1 and the swing axis A2). The swing mechanism 110 includes the first magnet 111 and the first coil 115. The first coil 115 is opposite to the first magnet 111 in the second direction Y.

The first magnet 111 is disposed in one of the holder 20 and the second support 60. On the other hand, the first coil 115 is disposed in the other of the holder 20 and the second support 60. Accordingly, the force acts on the first magnet 111 due to a magnetic field generated when the current flows through the first coil 115. The holder 20 swings with respect to the first support 30. Thus, the holder 20 can be swung with a simple configuration using the first magnet 111 and the first coil 115. In the example embodiment, the first magnet 111 is disposed in the holder 20. The first coil 115 is disposed on the second support 60. When the first coil 115 is disposed on the second support 60, the first coil 115 does not swing with respect to the second support 60. Accordingly, wiring can be easily performed on the first coil 115, for example, as compared with the case where the first coil 115 is disposed on the first support 30.

Specifically, the first magnet 111 is disposed in the back surface 21b of the holder 20. That is, the first magnet 111 is disposed at an end 20a on the other side Y2 in the second direction Y of the holder 20. The first magnet 111 includes an n-pole unit 111a including an n-pole and an s-pole unit 111b including an s-pole. The first magnet 111 is polarized in the first direction X.

The first coil 115 is disposed in the accommodation hole 63a of the back surface unit 63 of the second support 60. That is, the first coil 115 is disposed at an end 60a on the other side Y2 in the second direction Y of the second support 60. Accordingly, the first coil 115 and the first magnet 111 can be prevented from being disposed on the light path. Thus, the light path can be prevented from being blocked by the first coil 115 and the first magnet 111.

When the first coil 115 is energized, the magnetic field is generated around the first coil 115. Then, the force caused by the magnetic field acts on the first magnet 111. As a result, the holder 20 and the optical element 10 swing about the swing axis A1 with respect to the first support 30 and the second support 60.

The swing mechanism 120 swings the movable body 2 about the swing axis A2. Specifically, the swing mechanism 120 swings the first support 30 about the swing axis A2 with respect to the second support 60. The swing mechanism 120 includes the second magnet 121 and the second coil 125 opposite to the second magnet 121. The second magnet 121 is an example of the “swing magnet” of the present disclosure. The second coil 125 is an example of the “swing coil” of the present disclosure. The second magnet 121 is disposed on the movable body 2 or the fixed body 3. The second coil 125 is disposed on the fixed body 3 or the movable body 2. In the example embodiment, the second magnet 121 is disposed on one of the first support 30 and the second support 60. On the other hand, the second coil 125 is disposed on the other of the first support 30 and the second support 60. Accordingly, the first support 30 swings with respect to the second support 60 by the magnetic field generated when the current flows through the second coil 125. Thus, the first support 30 can be swung with a simple configuration using the second magnet 121 and the second coil 125. In the example embodiment, the second magnet 121 is disposed on the first support 30. The second coil 125 is disposed on the second support 60. When the second coil 125 is disposed on the second support 60, the second coil 125 does not swing with respect to the second support 60. Accordingly, the wiring can be easily performed on the second coil 125, for example, as compared with the case where the second coil 125 is disposed on the first support 30.

Specifically, the second magnet 121 is disposed in the accommodation recess 32f (see FIG. 8) of the side surface unit 32 of the first support 30. That is, the second magnet 121 is disposed at an end 30a in the direction intersecting with the first direction X of the first support 30. In the example embodiment, the second magnet 121 is disposed at the end 30a of the third direction Z. The second magnet 121 includes an n-pole unit 121a including the n-pole and an s-pole unit 121b including the s-pole. The second magnet 121 is polarized in the second direction Y intersecting with the first direction X. Accordingly, the movable body 2 can be swung about the swing axis A2 along the incident direction of light.

The second coil 125 is opposite to the second magnet 121 in the third direction Z. The second coil 125 is disposed in the accommodation hole 62a (see FIG. 12) of the side surface unit 62 of the second support 60. That is, the second coil 125 is disposed at an end 60b in the third direction Z of the second support 60.

When the second coil 125 is energized, the magnetic field is generated around the second coil 125. Then, the force caused by the magnetic field acts on the second magnet 121. As a result, the first support 30, the holder 20, and the optical element 10 swing about the swing axis A2 with respect to the second support 60.

The fixed body 3 of the optical assembly 1 is produced by attaching the attachment plate 153 on which the first magnet 151p and the second magnet 151q are disposed.

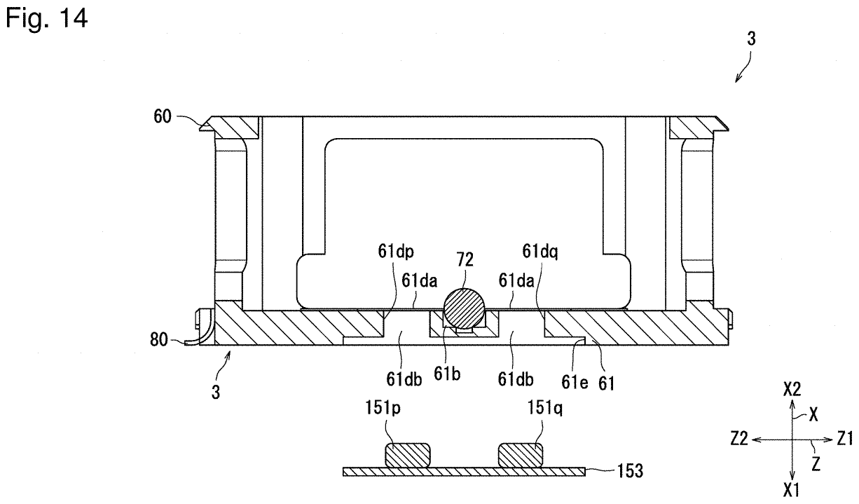

FIG. 14 is a view illustrating assembling of the fixed body 3 in the optical assembly 1 of the example embodiment. As illustrated in FIG. 14, the first magnet 151p and the second magnet 151q are attached to the attachment plate 153. The attachment plate 153 is attached to the fixed body 3 from one side X1 in the first direction toward the other side X2 in the first direction. Accordingly, the first magnet 151p is inserted into the through-hole 61dp of the second support 60, and the second magnet 151q is inserted into the through-hole 61dq of the second support 60.

The optical assembly 1 of the example embodiment includes the holder 20 on which the optical element 10 that reflects light traveling on one side X1 in the first direction to one side Y1 in the second direction intersecting with the first direction X is mounted, the first support 30 that supports the holder 20, the fixed body 3 that supports the first support 30, the swing mechanism 120 that swings the first support 30 about the swing axis A2 with respect to the fixed body 3, the first magnet 151p disposed on the fixed body 3, and the first magnetic body 152p disposed on the first support 30. When viewed from the first direction X, at least portions of the first magnet 151p and the first magnetic body 152p overlap each other. The first magnet 151p is located in the through-hole 61dp made in the first support 30.

At this point, the first magnet 151p is disposed on the fixed body 3, and the first magnetic body 152p is disposed on the first support 30. However, the first magnet 151p may be disposed on any one of three of the holder 20, the first support 30, and the fixed body 3, and the first magnetic body 152p may be disposed on any one of remaining two of three of the holder 20, the first support 30, and the fixed body 3.

At this point, at least portions of the first magnet 151p and the first magnetic body 152p overlap each other when viewed from the first direction X, but at least portions of the first magnet 151p and the first magnetic body 152p may overlap each other when viewed from any one of the first direction X, the second direction Y, and the third direction Z.

At this point, the first magnet 151p is located in the through-hole 61d made in the fixed body 3. However, at least one of the first magnet 151p and the first magnetic body 152p may be located in the through-hole. In this case, at least one of the first magnet 151p and the first magnetic body 152p may be located in the through-hole made in at least one of the first support 30 and the fixed body 3.

As described above, the optical assembly 1 of the example embodiment includes the holder 20 on which the optical element 10 that reflects light traveling to one side X1 in the first direction to one side Y1 in the second direction intersecting with the first direction X is mounted, the first support 30 that supports the holder 20, the fixed body 3 that supports the first support 30, the swing mechanism 120 that swings the first support 30 about the swing axis A2 with respect to the fixed body 3, the first magnet 151p arranged on any one of the three of the holder 20, the first support 30, and the fixed body 3, and the first magnetic body 152p arranged on any one of remaining two of three of the holder 20, the first support 30, and the fixed body 3. At least portions of the first magnet 151p and the first magnetic body 152p overlap each other when viewed from any one of the first direction X, the second direction Y, and the third direction Z intersecting with each of the first direction X and the second direction Y. At least one of the first magnet 151p and the first magnetic body 152p is located in a through-hole made in at least one of the first support 30 and the fixed body 3.

In the first magnet 151p and the first magnetic body 152p at least partially overlapping each other as viewed from any one of the first direction X in which light travels to the optical element 10, the second direction Y in which the optical element 10 reflects light, and the third direction intersecting with each of the first direction X and the second direction Y, at least one of the positions of the first magnet 151p and the first magnetic body 152p can be prevented from deviating by tolerance.

When viewed from the support direction in which the fixed body 3 supports the first support 30, at least portions of the first magnet 151p and the first magnetic body 152p overlap each other. Thus, in the first magnet 151p and the first magnetic body 152p at least partially overlapping each other when viewed from the support direction in which the fixed body 3 supports the first support 30, the position of at least one of the first magnet 151p and the first magnetic body 152p can be prevented from deviating by tolerance.

In the example embodiment, the first magnet 151p is disposed on the first support 30, and the first magnetic body 152p is disposed on the fixed body 3. In the first magnet 151p and the first magnetic body 152p at least partially overlapping with each other when viewed from any one of the first direction to the third direction, the position of at least one of the first magnet 151p and the first magnetic body 152p provided on the first support 30 and the fixed body 3 can be prevented from deviating by tolerance.

At this point, the first magnet 151p is disposed on the fixed body 3, and the first magnetic body 152p is disposed on the first support 30. However, the first magnet 151p may be disposed on one of the first support 30 and the fixed body 3, and the first magnetic body 152p may be disposed on the other of the first support 30 and the fixed body 3.

In this manner, the first magnet 151p is disposed on one of the first support 30 and the fixed body 3. The first magnetic body 152p is disposed on the other of the first support 30 and the fixed body 3. In the first magnet 151p and the first magnetic body 152p at least partially overlapping with each other when viewed from any one of the first direction to the third direction, the position of at least one of the first magnet 151p and the first magnetic body 152p provided on the first support 30 and the fixed body 3 can be prevented from deviating by tolerance.

At least one of the first magnet 151p and the first magnetic body 152p and the swing mechanism 120 are disposed on different surfaces. At least one of the first magnet 151p and the first magnetic body 152p can be prevented from magnetically interfering with the swing mechanism 120.

The first magnet 151p is disposed in the through-hole 61d. The through-hole 61d includes an opening 61da at one end located on the side of the first magnetic body 152p and an opening 61db at the other end located farther than the opening 61da at one end with respect to the first magnetic body 152p. A distance between the first magnet 151p and the opening 61da at one end in the through-hole 61d is smaller than a distance between one side of the first magnet 151p and the opening 61db at the other end in the through-hole 61d. The attractive force between the first magnet 151p and the first magnetic body 152p can be increased by disposing the first magnet 151p near the other of the first magnetic body 152p in the through-hole 61d.

At this point, the first magnet 151p is disposed in the through-hole 61d, but one of the first magnet 151p and the first magnetic body 152p may be disposed in the through-hole 61d.

One of the first magnet 151p and the first magnetic body 152p is disposed in the through-hole 61d. The through-hole 61d includes the opening 61da at one end located on the other side of the first magnet 151p and the first magnetic body 152p and the opening 61db at the other end located farther than the opening 61da at one end with respect to the other of the first magnet 151p and first magnetic body 152p. A distance between one of the first magnet 151p and the first magnetic body 152p in the through-hole 61d and the opening 61da at one end may be smaller than a distance between one of the first magnet 151p and the first magnetic body 152p in the through-hole 61d and the opening 61db at the other end. The attractive force between the first magnet 151p and the first magnetic body 152p can be increased by disposing one of the first magnet 151p and the first magnetic body 152p near the other of the first magnet 151p and the first magnetic body 152p in the through-hole 61d.

In the above-described example embodiment, the first magnet 151p is disposed in the through-hole 61d. The through-hole 61d includes an opening 61da at one end located on the side of the first magnetic body 152p and an opening 61db at the other end located farther than the opening 61da at one end with respect to the first magnetic body 152p. The optical assembly 1 further includes the attachment plate 153 that is located on the side of the opening 61db at the other end with respect to the first magnet 151p in the through-hole 61d and to which the first magnet 151p is attached. The first magnet 151p can be easily inserted by the attachment plate 153 to which the first magnet 151p is attached.

In this case, the first magnet 151p is disposed in the through-hole 61d. The through-hole 61d includes an opening 61da at one end located on the side of the first magnetic body 152p and an opening 61db at the other end located farther than the opening 61da at one end with respect to the first magnetic body 152p. The optical assembly 1 further includes the attachment plate 153 that is located on the side of the opening 61db at the other end with respect to the first magnet 151p in the through-hole 61d and to which the first magnet 151p is attached. One of the first magnet 151p and the first magnetic body 152p can be easily inserted by the attachment plate 153 to which the first magnet 151p is attached.

The fixed body 3 further includes an adhesive located in the through-hole 61d. The adhesive can prevent the first magnet 151p from being displaced in the through-hole 61d. Furthermore, the adhesive can prevent the first magnet 151p from rusting.

At least one of the first magnet 151p and the first magnetic body 152p may be located in the through-hole 61d. The optical assembly 1 further includes the adhesive located in the through-hole 61d. The adhesive can prevent at least one of the first magnet 151p and the first magnetic body 152p from being displaced in the through-hole 61d. Furthermore, the adhesive can prevent the first magnet 151p and the first magnetic body 152p from rusting.

In this manner, one of the first magnet 151p and the first magnetic body 152p is disposed in the through-hole 61d. The through-hole 61d includes the opening 61da at one end located on the other side of the first magnet 151p and the first magnetic body 152p and the opening 61db at the other end located farther than the opening 61da at one end with respect to the other of the first magnet 151p and first magnetic body 152p. In the through-hole 61d, the optical assembly 1 further includes the attachment plate 153 that is located on the side of the opening 61db at the other end with respect to one of the first magnet 151p and the first magnetic body 152p and to which one of the first magnet 151p and the first magnetic body 152p is attached. One of the first magnet 151p and the first magnetic body 152p can be easily inserted by the attachment plate 153 to which one of the first magnet 151p and the first magnetic body 152p is attached.

The through-hole 61d is located in the fixed body 3. One of the first magnet 151p and the first magnetic body 152p can be easily inserted into the through-hole 61d by providing the through-hole 61d in the fixed body 3 located outside the first support 30.

The first magnet 151p is located in the fixed body 3. Even when a magnet is used in swinging the holder 20 with respect to the first support 30, the influence on the first magnet 151p can be prevented.

The optical assembly 1 further includes the second magnet 151q disposed on any one of three of the holder 20, the first support 30, and the fixed body 3, and the second magnetic body 152q disposed on any one of remaining two of three of the holder 20, the first support 30, and the fixed body 3. At least portions of the second magnet 151q and the second magnetic body 152q overlap each other when viewed from any one of the first direction X, the second direction Y, and the third direction Z. At least one of the second magnet 151q and the second magnetic body 152q is located in a through-hole made in at least one of the first support 30 and the fixed body 3. The first support 30 can be stably supported with respect to the fixed body by a plurality of magnetic springs.

The through-hole 61d in which one of the first magnet 151p and the first magnetic body 152p is disposed includes an opening at one end located on the other side of the first magnet 151p and the first magnetic body 152p and an opening at the other end located farther than the opening 61da at one end with respect to the other of the first magnet 151p and the first magnetic body 152p. The through-hole in which one of the second magnet 151q and the second magnetic body 152q is disposed includes an opening at one end located on the other side of the second magnet 151q and the second magnetic body 152q and an opening at the other end located farther than the opening 61da at one end with respect to the other of the second magnet 151q and the second magnetic body 152q.

A distance between one of the first magnet 151p and the first magnetic body 152p and the opening 61da at one end of the through-hole 61dp is equal to a distance between one of the second magnet 151q and the second magnetic body 152q and the opening 61da at one end of the through-hole 61dq. The magnetic force can be uniformly applied to two or more places by equalizing the distances between the magnet 151 and the magnetic body 152 in the through-hole 61dp and the opening 61da at one end of the through-hole.

The optical assembly 1 further includes the swing mechanism 110 that swings the holder 20 about the swing axis A1 intersecting with the swing axis A2 with respect to the first support 30. The swing mechanism 120 can swing the holder 20 about the swing axis A1 intersecting with the swing axis A2.

The first magnet 151p and the second magnet 151q are located symmetrically with respect to the direction (swing axis A1) orthogonal to the swing axis A2 when viewed from the first direction X. The first magnetic body 152p and the second magnetic body 152q are located symmetrically with respect to the direction (swing axis A1) orthogonal to the swing axis A2 when viewed from the first direction X. As a result, the first support 30 can be arranged symmetrically on the swing axis A1 with respect to the fixed body 3.

When the optical assembly 1 is used for the smartphone 200 as illustrated in FIG. 1, the smartphone 200 includes the optical assembly 1 described above. Thus, the optical assembly 1 can be used for the smartphone 200.

The Hall element (not illustrated) in the smartphone 200 detects the posture of the smartphone 200. The swing mechanism 110 and the swing mechanism 120 are controlled in response to the attitude of the smartphone 200. Preferably, the optical assembly 1 can detect the attitude of the holder 20 with respect to the second support 60. In this case, the attitude of the holder 20 can be controlled with high accuracy with respect to the second support 60. For example, a gyro sensor may be used as a sensor that detects the attitude of the smartphone 200.

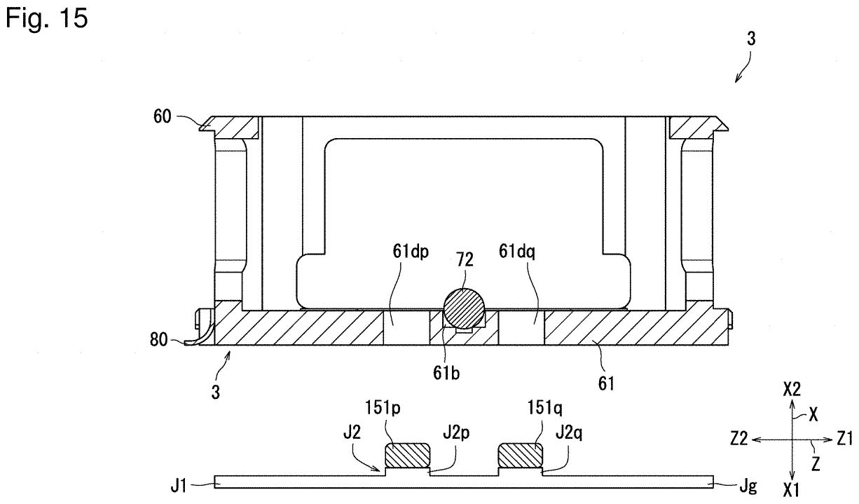

With reference to FIGS. 15 to 22, a modification of the example embodiment will be described below. Hereinafter, differences from the example embodiment shown in FIGS. 1 to 14 will be mainly described.

With reference to FIG. 15, the modification of the example embodiment of the present disclosure will be described. FIG. 15 is a sectional view illustrating the manufacturing of the fixed body 3 of the optical assembly 1 according to the modification of the example embodiment.

As illustrated in FIG. 15, the fixed body 3 may be produced using a jig Jg. The jig Jg includes a flat unit J1 and a protrusion J2. The flat unit J1 is a flat plate member extending in an XY-plane. The protrusion J2 protrudes from the flat unit J1 toward the other side X2 in the first direction X. The protrusion J2 includes a protrusion J2p and a protrusion J2q. Each of the protrusion J2p and the protrusion J2q has a rectangular parallelepiped shape. The protrusion J2p and the protrusion J2q are located symmetrically on the swing axis A1 when viewed from the first direction X.

The first magnet 151p is disposed on the other side X2 in the first direction X of the protrusion J2p. The second magnet 151q is disposed on the other side X2 in the first direction X of the protrusion J2q.

For example, the lengths in the first direction X of the protrusion J2p and the first magnet 151p are substantially equal to the length in the first direction X of the through-hole 61dp. However, the lengths in the first direction X of the protrusion J2p and the first magnet 151p may be shorter than the length in the first direction X of the through-hole 61dp.

Similarly, the lengths in the first direction X of protrusion J2q and second magnet 151q are substantially equal to the length in the first direction X of through-hole 61dq. However, the lengths in the first direction X of the protrusion J2q and the first magnet 151p may be shorter than the length in the first direction X of the through-hole 61dq.

When the second magnet 151q is disposed on the protrusion J2q while the first magnet 151p is disposed on the protrusion J2p, the jig Jg is inserted into the second support 60. Thus, the first magnet 151p is inserted into the through-hole 61dp, and the second magnet 151q is inserted into the through-hole 61dq.

The first magnet 151p and the second magnet 151q are fixed to the through-hole 61dp and the through-hole 61dq while being inserted into the through-hole 61dp and the through-hole 61dq. For example, when the adhesive is injected while the first magnet 151p and the second magnet 151q are inserted into the through-hole 61dp and the through-hole 61dq, the first magnet 151p and the second magnet 151q are fixed to the through-hole 61dp and the through-hole 61dq.

Thereafter, the jig Jg is removed from the second support 60. Consequently, the fixed body 3 in which the first magnet 151p and the second magnet 151q are inserted into the through-hole 61dp and the through-hole 61dq can be manufactured.

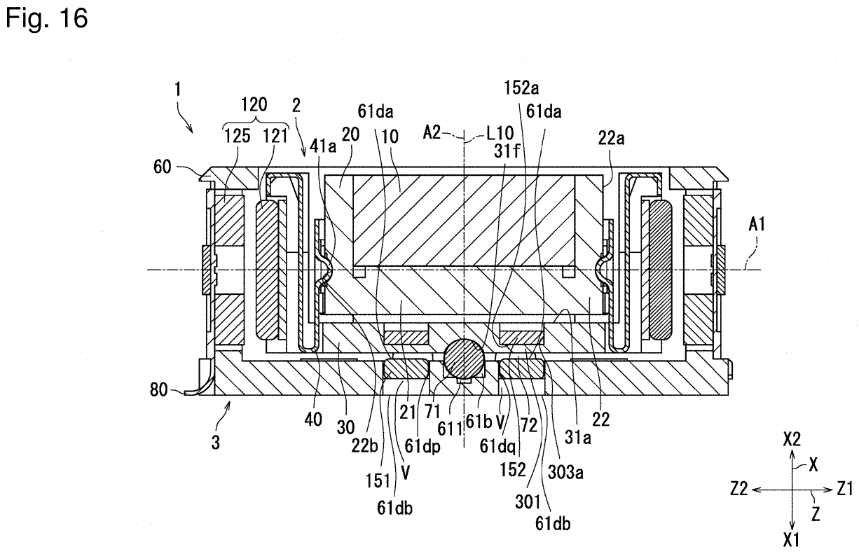

FIG. 16 is a sectional view illustrating a structure of the optical assembly 1 according to the modification of the example embodiment. As illustrated in FIG. 16, in the through-hole 61d, a gap V is provided between the first magnet 151p and the opening 61db at the other end. The gap V is provided in a wide space with respect to the first magnet 151p in the through-hole 61d where the first magnet 151p is located. Such the gap V is suitably formed when the first magnet 151p is disposed in the through-hole 61d using the jig Jg.

One of the first magnet 151p and the first magnetic body 152p may be disposed in the through-hole 61d. In the through-hole 61d, the gap V is provided between one of the first magnet 151p and the first magnetic body 152p and the opening 61db at the other end. The gap V is provided in a wide space with respect to one of the first magnet 151p and the first magnetic body 152p in the through-hole 61d in which one of the first magnet 151p and the first magnetic body 152p is located. Such the gap V is suitably formed when one of the first magnet 151p and the first magnetic body 152p is disposed in the through-hole 61d using the jig Jg.

Similarly, in the through-hole 61d, the gap V is provided between one of the second magnet 151q and the second magnetic body 152q and the opening 61db at the other end. The gap V is provided in a space wider than one of the second magnet 151q and the second magnetic body 152q in the through-hole 61d in which one of the second magnet 151q and the second magnetic body 152q is located. Such the gap V is suitably formed when one of the second magnet 151q and the second magnetic body 152q is disposed in the through-hole 61d using the jig Jg.

In the optical assembly 1 of FIG. 16, the first magnet 151p is located on substantially the same plane as the bottom surface of the second support 60, and the second magnet 151q is located on substantially the same plane as the bottom surface of the second support 60. However, the example embodiment is not limited to this. The first magnet 151p may be located away from the opening 61da at one end of the through-hole 61dp, and the second magnet 151q may be located away from the opening 61da at one end of the through-hole 61dp. Even in this case, the distance between the first magnet 151p and the opening 61da at one end in the through-hole 61d is preferably smaller than the distance between the first magnet 151p and the opening 61db at the other end in the through-hole 61d. The attractive force between the first magnet 151p and the first magnetic body 152p can be increased by disposing the first magnet 151p near the first magnetic body 152p in the through-hole 61d.

As described above, the distance between one of the first magnet 151p and the first magnetic body 152p in the through-hole 61d and the opening 61da at one end is preferably smaller than the distance between one of the first magnet 151p and the first magnetic body 152p in the through-hole 61d and the opening 61db at the other end. The attractive force between the first magnet 151p and the first magnetic body 152p can be increased by disposing one of the first magnet 151p and the first magnetic body 152p near the other of the first magnet 151p and the first magnetic body 152p in the through-hole 61d.

In the fixed body 3 of FIG. 16, the gap V is provided between the second magnet 151q and the opening 61db at the other end in the through-hole 61d. However, the gap V may be filled. For example, an adhesive layer made of an adhesive may be disposed in the gap V.

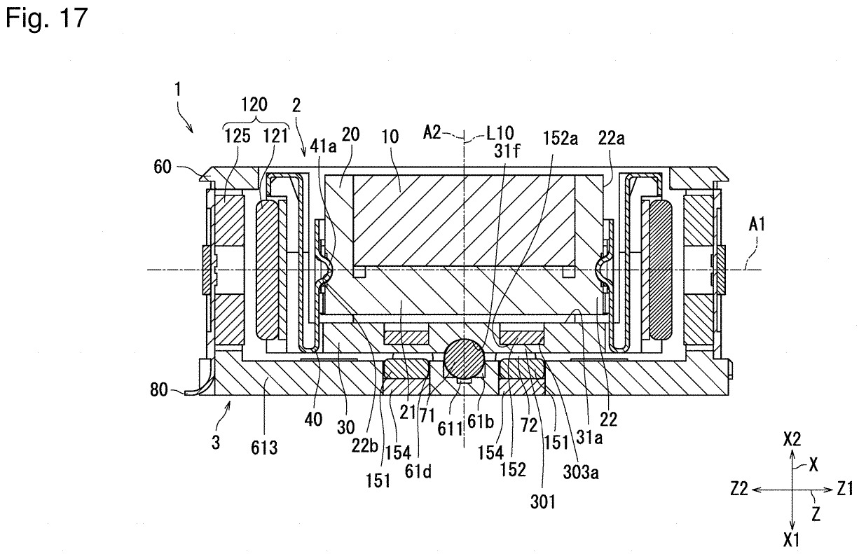

FIG. 17 is a sectional view illustrating the structure of the optical assembly 1 according to the modification of the example embodiment. As illustrated in FIG. 17, the first magnet 151p is disposed in the through-hole 61d. The through-hole 61d includes an opening 61da at one end located on the side of the first magnetic body 152p and an opening 61db at the other end located farther than the opening 61da at one end with respect to the first magnetic body 152p. The fixed body 3 further includes an adhesive layer 154 located between the first magnet 151p and the opening 61db at the other end in the through-hole 61d. The adhesive layer 154 is made of an adhesive.

One of the first magnet 151p and the first magnetic body 152p may be disposed in the through-hole 61d. One of the first magnet 151p and the first magnetic body 152p is disposed in the through-hole 61d. The through-hole 61d includes the opening 61da at one end located on the other side of the first magnet 151p and the first magnetic body 152p and the opening 61db at the other end located farther than the opening 61da at one end with respect to the other of the first magnet 151p and first magnetic body 152p. The through-hole 61d further includes the adhesive layer 154 located between one of the first magnet 151p and the first magnetic body 152p and the opening 61db at the other end.

The adhesive layer 154 is provided in a wide space with respect to one of the first magnet 151p and the first magnetic body 152p in the through-hole 61dp where one of the first magnet 151p and the first magnetic body 152p is located. One of the first magnet 151p and the first magnetic body 152p is disposed in the through-hole 61dp using the jig and then the gap is filled with the adhesive, thereby suitably forming such the adhesive layer 154.

In FIG. 17, the adhesive layer 154 is provided between the first magnet 151p and the opening 61db at the other end of the through-hole 61d. However, the adhesive layer may be provided at another position.

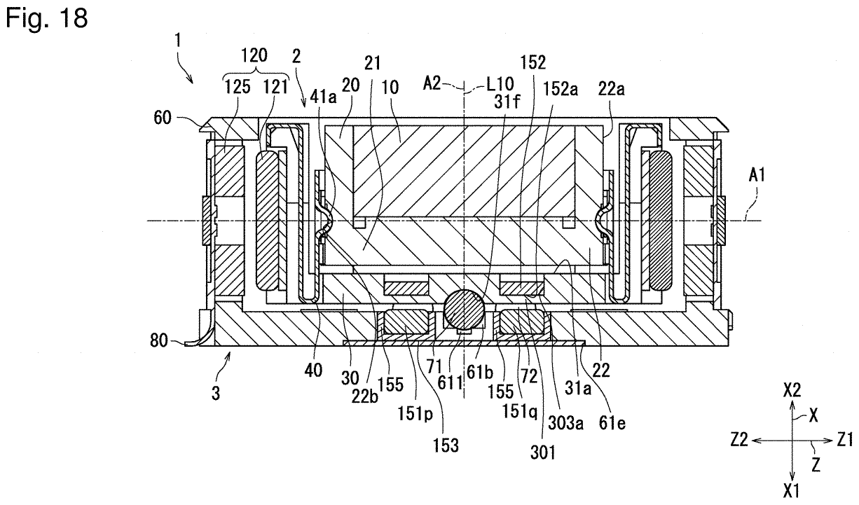

FIG. 18 is a perspective view illustrating the optical assembly 1 of the example embodiment. As illustrated in FIG. 18, the optical assembly 1 further includes an adhesive layer 155 located between the first magnet 151p and the attachment plate 153 in the through-hole 61d. One of the first magnet 151p and the first magnetic body 152p can be bonded to the attachment plate 153 by the adhesive layer 155.

The optical assembly 1 further includes the adhesive layer 155 located between one of the first magnet 151p and the first magnetic body 152p and the attachment plate 153 in the through-hole 61d. One of the first magnet 151p and the first magnetic body 152p can be bonded to the attachment plate 153 by the adhesive layer 155.

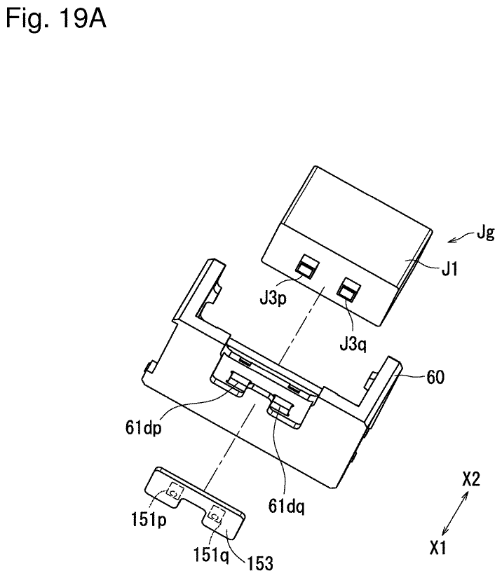

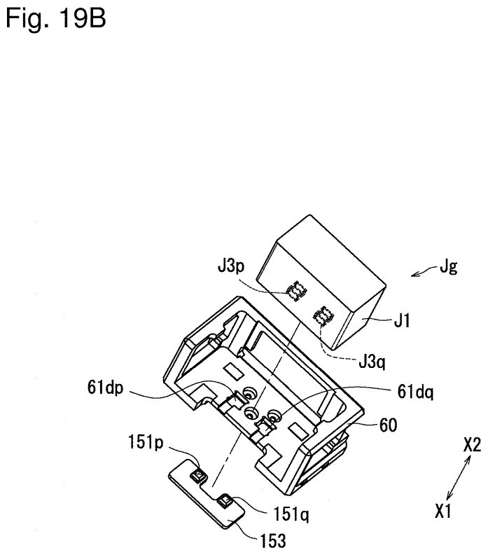

With reference to FIGS. 19A and 19B, the modification of the example embodiment of the present disclosure will be described below. FIGS. 19A and 19B are sectional views illustrating manufacturing of the fixed body 3 of the optical assembly 1 according to the modification of the example embodiment.

As illustrated in FIGS. 19A and 19B, the fixed body 3 may be manufactured using the jig Jg. The jig Jg includes the flat unit J1 and a protrusion J3. The flat unit J1 is a flat plate member extending in an XY-plane. The protrusion J3 protrudes from the flat unit J1 toward one side X1 in the first direction X. The protrusion J3 includes a protrusion J3p and a protrusion J3q. Each of the protrusion J3p and the protrusion J3q has a hollow box shape with one end opened. The protrusion J3p and the protrusion J3q are located symmetrically on the swing axis A1 when viewed from the first direction X.

The first magnet 151p and the second magnet 151q are attached to the attachment plate 153. The attachment plate 153 is attached to the fixed body 3 from one side X1 in the first direction toward the other side X2 in the first direction. In this case, the magnet 151 includes the first magnet 151p and the second magnet 151q. The first magnet 151p and the second magnet 151q are arrayed along the third direction Z. Accordingly, the first magnet 151p is inserted into the through-hole 61dp of the second support 60, and the second magnet 151q is inserted into the through-hole 61dq of the second support 60.

The outer diameter of the protrusion J3p is substantially equal to the inner diameter of the through-hole 61dp of the second support 60. The inner diameter of the protrusion J3p is substantially equal to the outer diameter of the first magnet 151p. Similarly, the outer diameter of the protrusion J3q is substantially equal to the inner diameter of the through-hole 61dq of the second support 60. The inner diameter of the protrusion J3q is substantially equal to the outer diameter of the second magnet 151q.

Therefore, the first magnet 151p and the second magnet 151q attached to the attachment plate 153 are inserted into the protrusion J3p and the protrusion J3q while the protrusion J3p and the protrusion J3q of the jig Jg are inserted into the through-hole 61dp and the through-hole 61dq of the second support 60, whereby the first magnet 151p and the second magnet 151q can be positioned with high accuracy.

In this case, the adhesive is preferably applied around the first magnet 151p and the second magnet 151q before the first magnet 151p and the second magnet 151q are inserted. Consequently, the first magnet 151p and the second magnet 151q can accurately be positioned in the through-hole 61dp and the through-hole 61dq of the second support 60.

The magnet 151 is preferably used together with the yoke. Thus, the magnetic force of the magnet 151 can be increased.

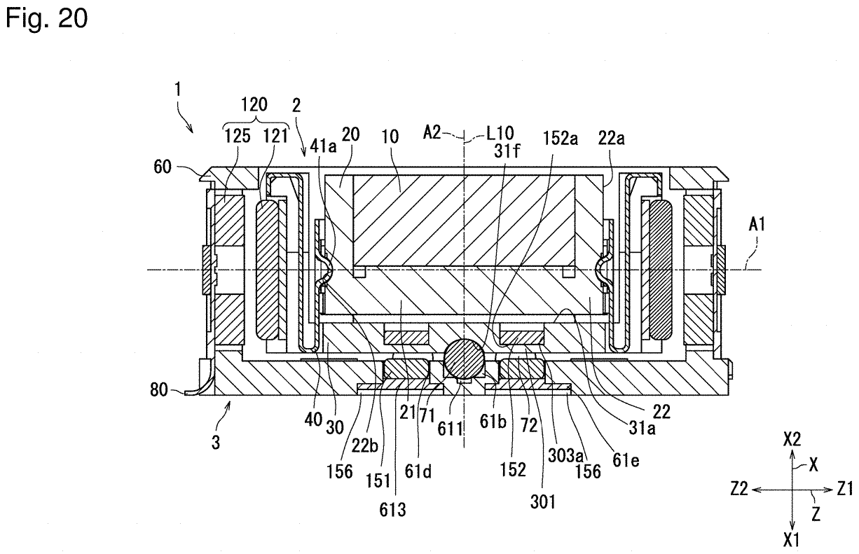

FIG. 20 is a sectional view illustrating the structure of the fixed body 3 in the optical assembly 1 according to the modification of the example embodiment.

As illustrated in FIG. 20, the optical assembly 1 further includes a yoke 156 that is in contact with the first magnet 151p on the side opposite to the side where the first magnetic body 152p is located with respect to the first magnet 151p. The yoke 156 can increase the magnetic force of the first magnet 151p. The yoke 156 is disposed in the recess 61e.

Similarly, the yoke 156 that is in contact with second magnet 151q on the side opposite to the side where the second magnetic body 152q is located with respect to the second magnet 151q is further included. The yoke 156 can increase the magnetic force of the second magnet 151q. The yoke 156 is disposed in the recess 61e.

The length of the yoke 156 along the hole radial direction (for example, the third direction Z) orthogonal to the longitudinal direction (first direction X) in which the through-hole 61d extends is longer than the length of the first magnet 151p along the hole radial direction. The inner diameter of the through-hole 61d is larger than the length of the first magnet 151p along the hole radial direction and is smaller than the length of the yoke 156 along the hole radial direction. While the first magnet and the yoke are inserted from one side of the through-hole 61d, the first magnet 151p and the yoke 156 can be prevented from coming out from the other side of the through-hole 61d.

The through-hole 61d in which the first magnet 151p is located and the recess 61e connected to the through-hole 61d are provided in the fixed body 3. The inner diameter of the recess 61e is larger than the length of the yoke 156 along the hole radial direction. The first magnet 151p can be disposed in the through-hole 61d, and the yoke 156 can be disposed in the recess 61e.

The first magnet 151p may be disposed on one of the first support 30 and the fixed body 3. The through-hole 61d in which the first magnet 151p is located and the recess 61e connected to the through-hole 61d are provided in one of the first support 30 and the fixed body 3. The inner diameter of the recess 61e is larger than the length of the yoke 156 along the hole radial direction. The first magnet 151p can be disposed in the through-hole 61d, and the yoke 156 can be disposed in the recess.

Although the optical assembly 1 in FIG. 20 has a flange structure in which the first magnet 151p having a quadrangular shape and the yoke 156 having a width larger than that of the first magnet 151p are integrated. However, the example embodiment is not limited thereto. The first magnet 151p itself may have the flange structure.

The through-hole 61d may be configured such that the magnet 151 or the magnetic body 152 cannot pass therethrough.

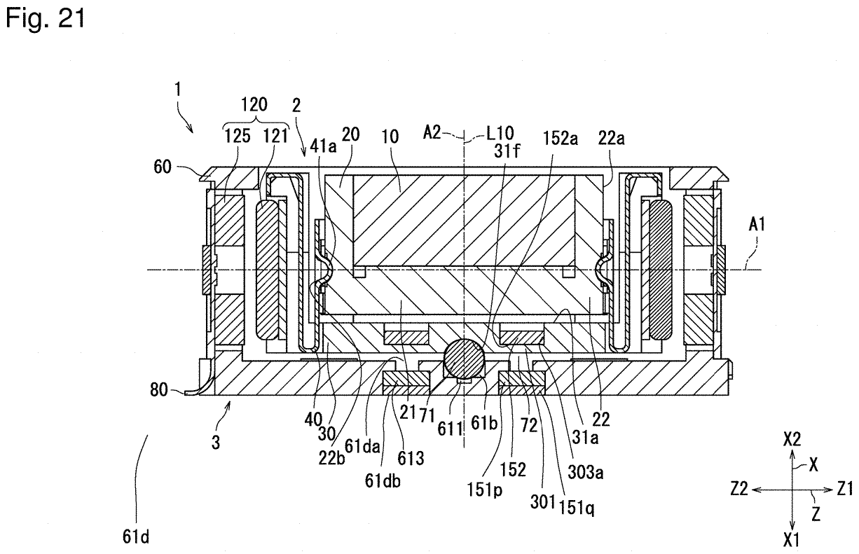

FIG. 21 is a view illustrating the section of the optical assembly 1 of the example embodiment.

As illustrated in FIG. 21, one of the first magnets 151p is disposed in the through-hole 61d. The through-hole 61d includes an opening 61da at one end located on the side of the first magnetic body 152p and an opening 61db at the other end located farther than the opening 61da at one end with respect to the first magnetic body 152p. The inner diameter of the opening 61da at one end of the through-hole 61d is smaller than the length of one of the first magnet 151p and the first magnetic body 152p along the hole radial direction (the second direction Y or the third direction Z) orthogonal to the longitudinal direction (first direction X) in which the through-hole 61d extends. The inner diameter of the opening 61db at the other end of the through-hole 61d is larger than the length of one of the first magnet 151p and the first magnetic body 152p along the hole radial direction (the second direction Y or the third direction Z).

One of the first magnet 151p and the first magnetic body 152p is disposed in the through-hole 61d. The through-hole 61d includes the opening at one end located on the other side of the first magnet 151p and the first magnetic body 152p and the opening at the other end located farther than the opening 61da at one end with respect to the other of the first magnet 151p and the first magnetic body 152p. The inner diameter of the opening 61da at one end of the through-hole 61d is smaller than the length of one of the first magnet 151p and the first magnetic body 152p along the hole radial direction (the second direction Y or the third direction Z) orthogonal to the longitudinal direction (first direction X) in which the through-hole 61d extends. The inner diameter of the opening 61db at the other end of the through-hole 61d is larger than the length of one of the first magnet 151p and the first magnetic body 152p along the hole radial direction (the second direction Y or the third direction Z). One of the first magnet 151p and the first magnetic body 152p can be suppressed from jumping out inward from the through-hole 61d.

In the optical assembly 1 of FIGS. 1 to 21, the through-hole 61d is disposed in the fixed body 3. However, the example embodiment is not limited thereto.

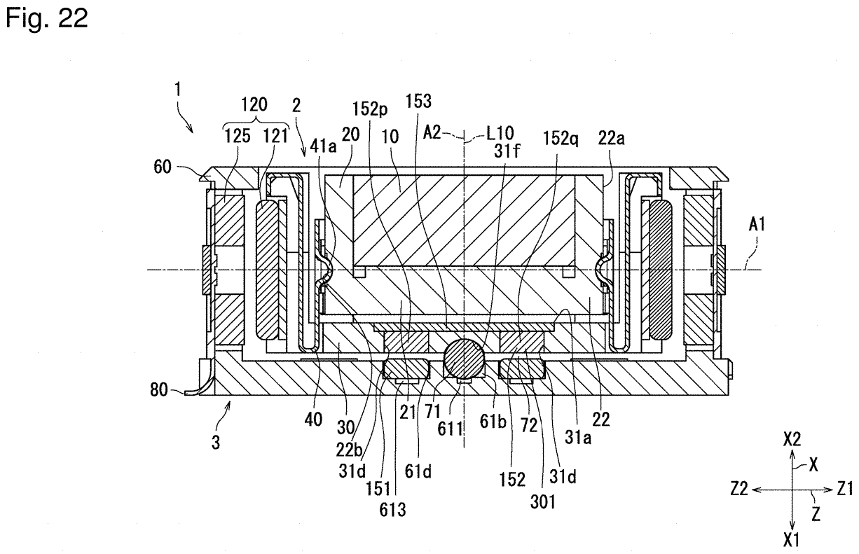

FIG. 22 is a view illustrating the section of the optical assembly 1 of the example embodiment. As illustrated in FIG. 22, the first support 30 includes a through-hole 31d. The first support 30 has a plurality of through-holes 31d. In the example embodiment, the fixed body 3 has two through-holes 31d. The magnetic body 152 may be disposed in the through-hole 31d.

The example embodiment (including modifications) of the present disclosure has been described above with reference to the drawings. However, the present disclosure is not limited to the above-described example embodiment, and can be implemented in various modes without departing from a gist thereof. In addition, various inventions are conceivable by an appropriate combination of the constituent elements described in the foregoing exemplary example embodiment. For example, some components may be removed from all components illustrated in the example embodiment. For example, constituent elements described in different example embodiments may be appropriately combined. The components in the drawings are mainly and schematically illustrated for facilitating better understanding, and the thickness, length, number, interval, and the like of each illustrated component may be different from reality for the convenience of creating drawings. The material, shape, dimensions, and the like of each component described in the above example embodiment are merely examples and are not particularly limited, and various modifications can be made without substantially departing from the effects of the present disclosure.

For example, in the above-described example embodiment, the example in which the magnetic body 152 is disposed on the movable body 2 while the magnet 151 is disposed on the fixed body 3 has been described. However, the present disclosure is not limited thereto. For example, the magnetic body 152 may be disposed on the fixed body 3, and the magnet 151 may be disposed on the movable body 2.

Furthermore, in the above-described example embodiment, the example in which the entire magnetic body 152 is disposed inside the accommodation unit 303a has been described. However, the present disclosure is not limited thereto. A part of the magnetic body 152 may be disposed inside the accommodation unit 303a.

Furthermore, in the above-described example embodiment, the example in which the magnet 151 and the magnetic body 152 are disposed so as to overlap each other as viewed from the direction in which the fixed body 3 supports the movable body 2 has been described. However, the present disclosure is not limited thereto. The magnet 151 and the magnetic body 152 may be disposed so as to overlap each other as viewed from the direction intersecting with the direction in which the fixed body 3 supports the movable body 2.

Furthermore, in the above-described example embodiment, the example in which the fixed body 3 supports the movable body 2 in the direction (first direction X) along the direction in which the light L enters the optical element 10 has been described. However, the present disclosure is not limited thereto. For example, the fixed body 3 may support the movable body 2 in the direction (second direction Y) along the direction in which the light L exits from the optical element 10. Furthermore, the fixed body 3 may support the movable body 2 in the direction (third direction Z) intersecting with the direction in which the light L enters the optical element 10 and the direction in which the light L exits from the optical element 10.

Furthermore, for example, in the above-described example embodiment, the example in which the covering unit 301 covers the entire region of the contour of the magnetic body 152 has been described. However, the present disclosure is not limited thereto. For example, the covering unit 301 may cover a part of the contour of the magnetic body 152. In this case, for example, a plurality of covering units 301 covering the contour of the magnetic body 152 at equal intervals may be disposed.

In the above-described example embodiment, the example in which the magnetic body 152 is made of what is called the magnetic material is illustrated. However, the present disclosure is not limited to this. For example, the magnetic body 152 may be a magnet. That is, the magnetic body 152 may be a permanent magnet.

For example, the present disclosure can be used in the optical assembly and the method for manufacturing the optical assembly.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An optical assembly comprising:
a holder on which an optical element that reflects light traveling to one side in a first direction to one side in a second direction intersecting with the first direction is mounted;
a support that supports the holder;
a fixed body that supports the support;
a first swing mechanism that swings the support about a first swing axis with respect to the fixed body;
a first magnet on any one of the holder, the support, and the fixed body; and
a first magnetic body on any other one of the holder, the support, and the fixed body; wherein
at least portions of the first magnet and the first magnetic body overlap each other when viewed from any one of the first direction, the second direction, and a third direction intersecting with each of the first direction and the second direction; and
at least one of the first magnet and the first magnetic body is located in a through-hole in at least one of the support and the fixed body.

2. The optical assembly according to claim 1, wherein at least portions of the first magnet and the first magnetic body overlap each other when viewed from a support direction in which the fixed body supports the support.

3. The optical assembly according to claim 1, wherein
the first magnet is on one of the support and the fixed body; and
the first magnetic body is on another one of the support and the fixed body.

4. The optical assembly according to claim 1, wherein at least one of the first magnet and the first magnetic body and the first swing mechanism are on different surfaces.

5. The optical assembly according to claim 1, wherein
one of the first magnet and the first magnetic body is in the through-hole;
the through-hole includes:
an opening at a first end located on another side of the first magnet and the first magnetic body; and
an opening at a second end located farther than the opening at the first end with respect to the other of the first magnet and the first magnetic body; and
a distance between one of the first magnet and the first magnetic body in the through-hole and the opening at the first end is smaller than a distance between one of the first magnet and the first magnetic body in the through-hole and the opening at the second end.

6. The optical assembly according to claim 5, wherein in the through-hole, a gap is provided between one of the first magnet and the first magnetic body and an opening at the second end.

7. The optical assembly according to claim 1, further comprising an adhesive located in the through-hole.

8. The optical assembly according to claim 1, further comprising:
an adhesive layer located between one of the first magnet and the first magnetic body and an opening at a second end in the through-hole; wherein
one of the first magnet and the first magnetic body is in the through-hole; and
the through-hole includes:
an opening at a first end located on the other side of the first magnet and the first magnetic body; and
an opening at the second end located farther than the opening at the first end with respect to the other of the first magnet and the first magnetic body.

9. The optical assembly according to claim 1, further comprising:
an attachment plate that is located on an opening side of a second end with respect to one of the first magnet and the first magnetic body in the through-hole and to which one of the first magnet and the first magnetic body is attached; wherein
one of the first magnet and the first magnetic body is located in the through-hole; and
the through-hole includes:
an opening at a first end located on the other side of the first magnet and the first magnetic body; and
an opening at the second end located farther than the opening at the first end with respect to the other of the first magnet and the first magnetic body.

10. The optical assembly according to claim 9, further comprising an adhesive layer located between one of the first magnet and the first magnetic body and the attachment plate in the through-hole.

11. The optical assembly according to claim 1, wherein the through-hole is located in the fixed body.

12. The optical assembly according to claim 1, wherein the first magnet is located on the fixed body.

13. The optical assembly according to claim 1, wherein
one of the first magnet and the first magnetic body is located in the through-hole;
the through-hole includes:
an opening at a first end located on the other side of the first magnet and the first magnetic body; and
an opening at a second end located farther than the opening at the first end with respect to the other of the first magnet and the first magnetic body
an inner diameter of the opening of the first end in the through-hole is smaller than a length of one of the first magnet and the first magnetic body along a hole radial direction orthogonal to a longitudinal direction in which the through-hole extends; and
an inner diameter of the opening at the second end in the through-hole is larger than a length of one of the first magnet and the first magnetic body along the hole radial direction.

14. The optical assembly according to claim 1, further comprising a yoke movable to contact with the first magnet on a side opposite to a side where the first magnetic body is located with respect to the first magnet.

15. The optical assembly according to claim 14, wherein
a length of the yoke along a hole radial direction orthogonal to a longitudinal direction in which the through-hole extends is longer than a length of the first magnet along the hole radial direction; and
an inner diameter of the through-hole is larger than a length of the first magnet along the hole radial direction and is smaller than a length of the yoke along the hole radial direction.

16. The optical assembly according to claim 15, wherein
the through-hole in which the first magnet is located and a recess connected to the through-hole are provided in one of the support and the fixed body; and
an inner diameter of the recess is larger than the length of the yoke along the hole radial direction.

17. The optical assembly according to claim 1, further comprising:
a second magnet on any one of the holder, the support, and the fixed body; and
a second magnetic body on another one of the holder, the support, and the fixed body; wherein
at least portions of the second magnet and the second magnetic body overlap each other when viewed from any one of the first direction, the second direction, and the third direction; and
at least one of the second magnet and the second magnetic body is located in a through-hole in at least one of the support and the fixed body.

18. The optical assembly according to claim 17, wherein
a through-hole accommodating one of the first magnet and the first magnetic body includes:
an opening at a first end located on the other side of the first magnet and the first magnetic body; and
an opening at a second end located farther than the opening at the first end with respect to the other of the first magnet and the first magnetic body;
the through-hole in which one of the second magnet and the second magnetic body is located includes:
an opening at a third end located on the other side of the second magnet and the second magnetic body; and
an opening at a fourth end located farther than the opening at the third end with respect to the other of the second magnet and the second magnetic body; and
a distance between one of the first magnet and the first magnetic body and the opening at the first end of the through-hole is equal to a distance between one of the second magnet and the second magnetic body and the opening at the third end of the through-hole.

19. The optical assembly according to claim 17, wherein the first magnet and the second magnet are symmetrical with respect to a direction orthogonal to the first swing axis when viewed from the first direction; and
the first magnetic body and the second magnetic body are symmetrical with respect to the direction orthogonal to the first swing axis when viewed from the first direction.

20. The optical assembly according to claim 1, further comprising a second swing mechanism that swings the holder about a second swing axis intersecting with the first swing axis with respect to the support.

21. A smartphone comprising the optical assembly according to claim 1.
